(19) United States
(12) Patent Application Publication
(10) Pub. No.: US 2002/0083213 A1
(43) Pub. Date: Jun. 27, 2002

(54) Method and system for simulating and certifying complex business applications

(76) Inventors: Brien M. Oberstein, New York, NY (US); Samuel R. Johnson, New York, NY (US); Michael W. Johnson, New York, NY (US); Matthew C. Koehler, New York, NY (US); William D. Hollings, Acton (CA); David A. Rhodes JR., Oak Park, IL (US); Michael Muir, New York, NY (US)

Correspondence Address: PENNIE AND EDMONDS, 1155 AVENUE OF THE AMERICAS, NEW YORK, NY, 100362711

(21) Appl. No.: 09/955,376

(22) Filed: Sep. 17, 2001

Related U.S. Application Data
(60) Provisional application No. 60/233,458, filed on Sep. 18, 2000.
(60) Provisional application No. 60/297,116, filed on Jun. 8, 2001.

(51) Int. Cl. G06F 9/46

(52) U.S. Cl. 709/313

(57) ABSTRACT

A preferred embodiment of the invention utilizes embedded XML-based test documents to simulate programmable behavior. Scripted validations, and state-tracking and markup-defining visual presentations to simulated programmable behavior can be embedded into the test documents. Preferably, the test documents simulate control behavior not only at the network interface but also through a graphical user interface (“GUI”) with which a tester can interact manually during the testing process. Also preferably, the present invention is platform independent, to support a plurality of protocols and applications.

An alternate embodiment is configured to test internal systems, and also as a way to fine-tune scripts for external certification with counterparties.

### CROSS REFERENCE TO RELATED APPLICATIONS

This application claims the benefit of U.S. Provisional Application No. 60/233,458, filed Sep. 18, 2000, and U.S. Provisional Application No. 60/297,116, filed Jun. 8, 2001. The contents of each application are incorporated herein by reference in their entirety.

### BACKGROUND

Many companies currently communicate and transact directly with each other via messaging standards such as Financial Information Exchange (“FIX”) protocol, the Society for Worldwide Interbank Financial Telecommunication (“SWIFT”) protocol, and Simple Object Access Protocol (“SOAP”). As such firms increase the number of counterparties with whom they are connected, they encounter difficulties in matching the messaging implementations of such counterparties.

Manually connecting counterparties typically requires a labor-intensive series of certification testing to ensure business application-level and protocol-level compatibility. Typically one or more persons are involved at each site, interactively verifying test results via phone or e-mail. See FIG. 1. Because of the emphasis on manual effort, individual tests run slowly, and there are often difficulties coordinating staff availability and test scheduling. The same problems are encountered when a firm wants to perform testing on its own systems to ensure they are behaving properly and to detect any problems or weaknesses in advance.

There is thus a need for a system and method for testing and certifying compatibility of communication systems (as well as for performing internal testing on such systems) that efficiently automates steps currently performed manually.

### SUMMARY

The present invention solves many of the problems of the previous manual testing methods The invention replaces one end of a prior-art manual test with an automated Test Script running in a Certification Engine. This eliminates staffing and resource coordination issues, and allows users to run tests at any time. It also reduces the time and cost to run each individual test, and allows multiple counterparties to test against a firm's system concurrently.

Software of a preferred embodiment of the present invention is based on an application server architecture for hosting compatibility testing between counterparties. The software provides a platform for automating either side of a messaging-compatibility certification process, thus reducing the need for human interaction on at least one side of a testing cycle. Software of a preferred embodiment plays the role of a counterparty, simulating such counterparty's systems for the other party to test against. One embodiment is implemented to handle the FIX protocol, but other embodiments handle other existing and emerging network messaging formats in different markets and industries.

Software of a preferred embodiment formalizes each individual test into a Test Script, which improves consistency when running the same test across multiple users. Software of a preferred embodiment provides trackable, consistent results, improving the ability to determine the status of each user, and to compare results over time and across users. Software of a preferred embodiment provides sophisticated event logging to aid in determining where and why a particular test failed.

More generally, the present invention relates to a system and method for simulating at the network interface level the behavior of complex business systems for the purpose of testing and certifying network application compatibility and interoperability and for verifying the behavior of a firm's internal systems.

A preferred embodiment of the invention utilizes embedded XML-based test documents to simulate programmable behavior. Scripted validations, and state-tracking and markup-defining visual presentations to simulated programmable behavior can be embedded into the test documents. Preferably, the test documents simulate control behavior not only at the network interface but also through a graphical user interface (“GUI”) with which a tester can interact manually during the testing process. Also preferably, the present invention is platform independent, to support a plurality of protocols and applications.

An alternate embodiment is configured to test internal systems, and also as a way to fine-tune scripts for external certification with counterparties.

In one aspect, the present invention comprises an apparatus for testing and certifying compatibility between an emulated system and a testing system, comprising: (1) a messaging engine configured to communicate with said testing system and (2) a certification engine configured to communicate with said messaging engine; wherein said certification engine is further configured to emulate said tested system. In one embodiment, the invention comprises an apparatus as just described, wherein compatibility tests performed by said certification engine in conjunction with said testing system are constructed using scripts. In another embodiment, said certification engine is configured to communicate with a web server. In another embodiment, the certification engine is configured to communicate with a web server.

In another aspect, the present invention comprises a method of emulating an emulated system to enable compatibility testing of said tested system with a testing system, comprising the steps of: (1) defining a test plan; (2) identifying unique aspects of the tested system; (3) modifying scripts to model said tested system, including said unique aspects; and (4) permitting said testing system access to a server running said scripts. In one embodiment, the tested system uses a messaging engine. In another embodiment, the messaging engine is a FIX engine. In a further embodiment, the scripts comprise session-level scripts. In a further embodiment, the scripts comprise application-level scripts. In a still further embodiment, the step of modifying scripts comprises the steps of: (a) dynamically determining the behavior of the messaging engine by running tests and logging test results; (b) parsing said logged test results; and (c) determining how said messaging engine validates incoming messages and composes outgoing messages. In another embodiment, tests are run, logged, and parsed using test scripts, and a still further embodiment includes a step of adding customized wizpages.

In another aspect, the present invention comprises a method of testing compatibility of a testing system and an emulated system, comprising the steps of: (1) establishing communication with an emulating system that emulates behavior of the tested system; (2) receiving a test data request from said emulating system; (3) sending test data to said emulating system, wherein said test data corresponds to said test data request; and (4) receiving a message from said emulating system indicating that said test data was successfully received. In one embodiment, the behavior is emulated with scripts. In another embodiment, the test data comprises an order. In a further embodiment, the method further comprises the step of providing a visual indication of test results to a user.

In another aspect, the present invention comprises a method of emulating an emulated system to enable compatibility testing of said tested system with a testing system, comprising the steps of: (1) emulating behavior of said tested system; (2) establishing communication with the testing system; (3) sending a test data request to said testing system; (4) receiving test data from said testing system, wherein said test data corresponds to said test data request; and (5) sending a message to said testing system indicating that said test data was successfully received. In one embodiment, the behavior is emulated with scripts. In another embodiment, the test data comprises an order. A further embodiment comprises the step of providing a visual indication of test results to a user.

In a further aspect, the present invention comprises software for emulating an emulated system to enable compatibility testing of said tested system with a testing system, comprising:

(1) user interface software; (2) script writing software; (3) application messaging software using a network connection; (4) script executing software; and (5) test scripts. In one embodiment, the messaging software uses a FIX protocol. In another embodiment, the messaging software uses a FIXML protocol. In a further embodiment, the messaging software uses a FPML protocol. In a still further embodiment, the messaging software uses a SWIFT protocol. In another embodiment, one or more of said test scripts comprise event handling script functions. In another embodiment, the software further comprises dynamic HTML generating software controllable by a script. In another embodiment, the software further comprises software configured to provide a graphical user interface. In a further embodiment, the graphical user interface is enabled to provide a visual indication of test results.

In another aspect, the present invention comprises software for monitoring and controlling flow of messages within a messaging engine using scripts, comprising: (1) a script interpreting engine embedded into said messaging engine; (2) a script; and (3) an application programming interface between said messaging engine and said script, wherein said application programming interface is configured to pass inbound and outbound messages to said script. In one embodiment, the said application programming interface is configured provide to said script access to attributes of said messages. In another embodiment, the application programming interface is configured to enable said script to handle inbound and outbound messaging errors. In a further embodiment, the application programming interface is configured to enable said script to control messaging engine behavior by returning true or false values from script functions. In a still further embodiment. the application programming interface is configured to provide said script with access to services provided by a protocol engine or an application connected thereto. In another embodiment, the invention further comprises software for associating one or more scripts with one or more event sources, such that an instance of a script maintains program state across several different events and messages. In a further embodiment, the invention comprises software for declaring scripts and enabling said scripts to include libraries of other scripts.

In another aspect, the present invention comprises software for emulating an emulated transaction processing system to enable compatibility testing of said emulated system with a testing system, comprising: (1) a protocol definition; (2) a first set of scripts implementing said protocol definition; and (3) a second set of scripts linked to the first set of scripts, said second set of scripts emulating a transaction processing system that implements said protocol definition.

### BRIEF DESCRIPTION OF THE DRAWINGS

FIG. 1 depicts prior art manual testing and certification processes.

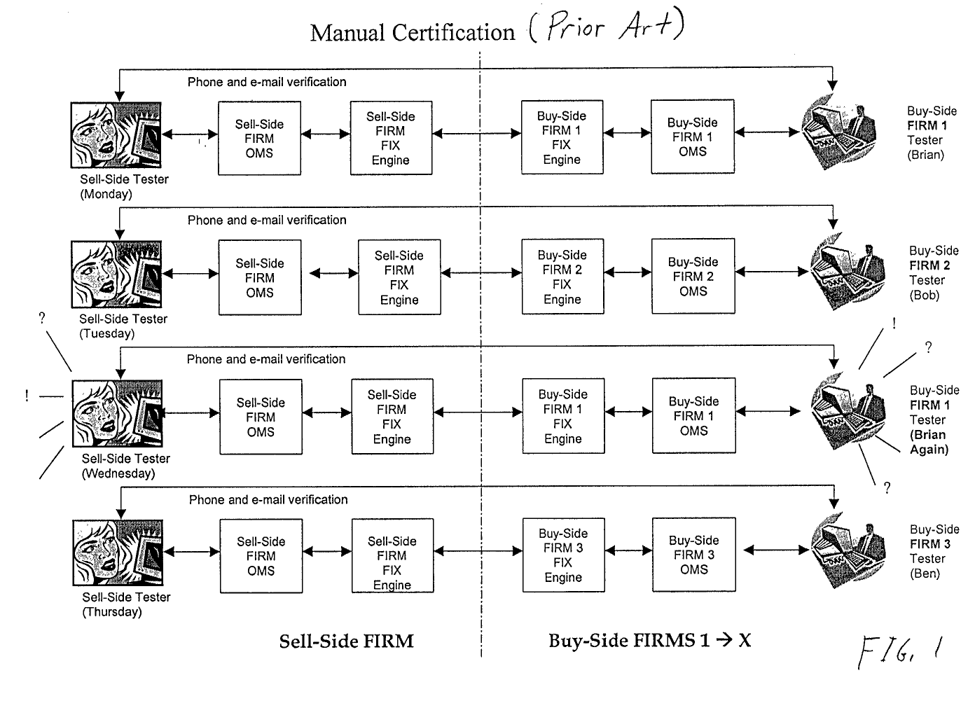

FIG. 2 depicts components of a preferred system.

FIG. 2A depicts states for a typical interactive test.

FIG. 3 depicts an alternate system embodiment.

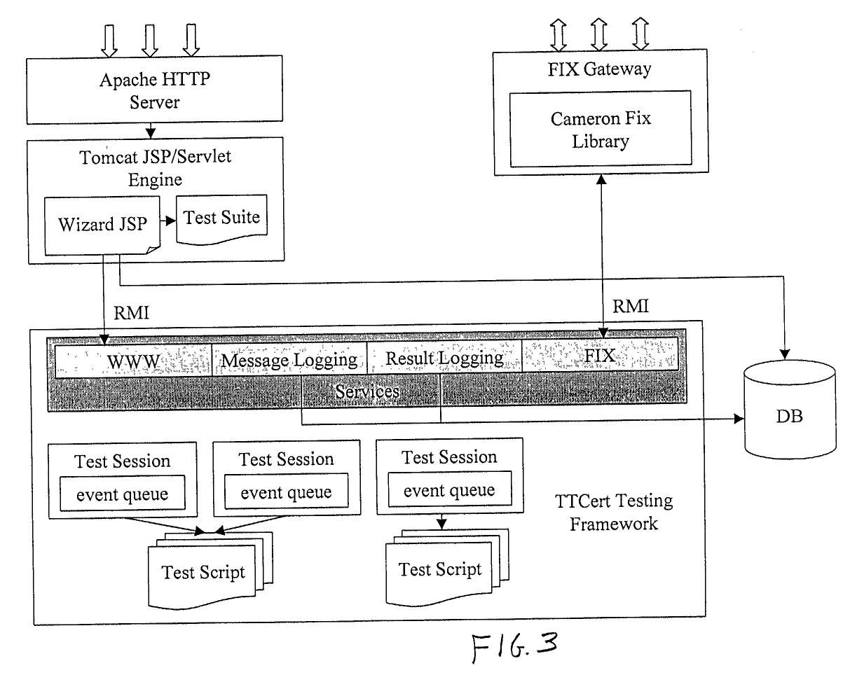

FIG. 4 depicts a preferred test session overview.

FIG. 5 depicts a preferred Test Script configuration.

FIG. 6 depicts a preferred Protocol Engine configuration.

FIG. 7 depicts steps of preferred testing workflow.

FIG. 8 depicts a preferred test suite page.

FIG. 9 depicts a preferred Admin Tools page.

FIG. 10 depicts a preferred Active Certification Sessions page.

FIG. 11 depicts a preferred current directory page.

FIG. 12 depicts a preferred script upload page.

FIG. 13 provides an overview of preferred script interaction.

FIG. 14 depicts a preferred connected wizpage asking for a test order.

FIG. 15 depicts a preferred event handler structure.

FIG. 16 illustrates preferred structure of a wizpage.

FIG. 17 depicts a buy-side firm testing against a sell-side counter party.

FIG. 18 depicts a sell-side firm testing against a buy-side counter party.

FIG. 19 illustrates benefits of a preferred embodiment used for internal testing.

FIG. 20 illustrates internal testing by a sell-side firm.

FIG. 21 illustrates internal testing by a buy-side firm.

FIG. 22 illustrates internal testing of automated scripts.

FIG. 23 illustrates loop back testing.

### DETAILED DESCRIPTION OF PREFERRED EMBODIMENTS

A preferred embodiment of the present invention provides a flexible, customizable environment for modeling a business process and underlying communications protocols, for the purpose of testing and validating both the business process logic and compliance with the communication protocols.

Manual certification testing requires not only that communication take place between counterparties' messaging engines, but also requires that the counterparties interactively verify testing results. As a corollary, an obstacle to the automation of certification testing is that interaction is required not only between the test server and the connected application (the counterparty's order management system), but also between the test server and the actual person testing on the other end. It is not enough to verify that a message was received by the connected application—a thorough test must also verify that appropriate information has been presented correctly to the person using that application. To address this problem, software of a preferred embodiment provides two means of automated interaction that are active at the same time: (1) an application messaging interface using a protocol network connection (FIX, for example); and (2) a user interface (a web browser, for example) that allows the counterparty performing the testing to view and interact with test results.

In a preferred embodiment, both of these means of interaction are controlled by a flexible scripting interface. A script defines the behavior of a firm's system for a particular business scenario, and the execution of the script reflects a single test of a business process or a portion of a business process (a complete compatibility test of some business scenarios may require several tests).

An illustrative example of a preferred implementation of a method of the invention is provided by two ECN-type securities trading networks, A and B. ECN A wishes to trade with ECN B. ECN B uses a FIX engine, a common messaging protocol engine for trading securities. ECN A wants to ensure through testing that its system is compatible with that of ECN B. A system T implementing a preferred embodiment of the present invention provides a testing service to ECNs A and B by gathering sufficient information from B to enable the system T to emulate the relevant operations of system B for the purpose of testing (and eventually certifying) system A's compatibility with system B.

Interaction of a system B (the system to be emulated) with an example preferred system T comprises the following preferred steps:

(1) Define a test plan. A test plan comprises certification tests that in the past would have been performed manually. These certification tests are implemented into scripts by system T.

(2) Identify unique aspects of system B's business processing with regard to FIX. In this step, B identifies optional fields and formatting in the FIX protocol that its system requires. B also identifies custom fields that it has added for its business processes, and identifies changes to the semantics of the FIX protocol that it has made to support its business processes.

(3) Download and modify scripts from T's server. Using applicable scripted logic provided by system T, B writes a subset of scripts to capture behavior unique to its system. These smaller scripts are linked to the original set of scripts from T's server. B sets up specific data formats for ID fields and adds customized FIX session enhancements.

(4) B debugs scripts that it has written.

(5) B uploads its scripts to system T's server, preferably using T's site administration tools. T's scripts should now behave the same way as B's FIX engine when receiving, validating, and sending FIX messages.

(6) Alert counter-parties (e.g., system A) that system B is now emulated on system T. B provides IDs, passwords, and licenses, as necessary.

(7) View test progress. Preferably, B can view the progress of its counter-parties' testing, using Session Monitor and Log Viewer software of a preferred embodiment, discussed below.

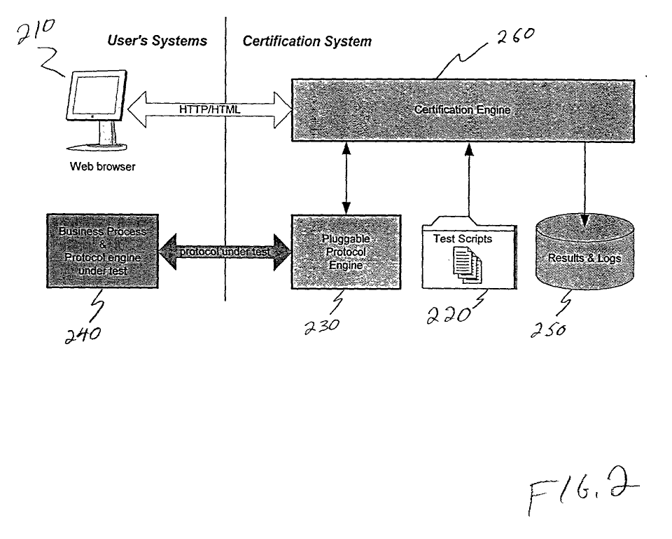

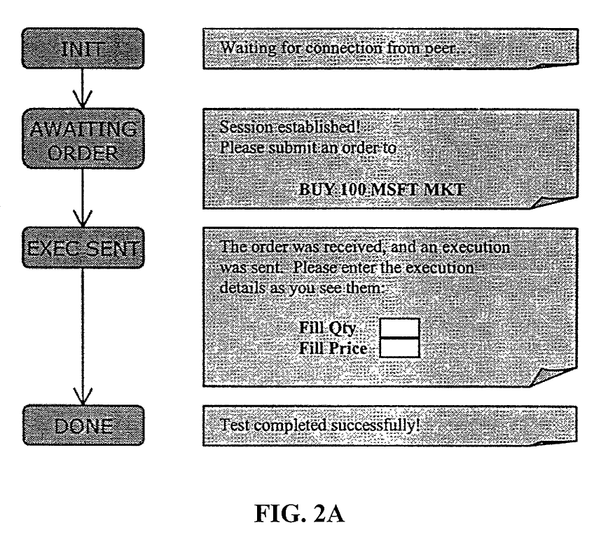

Once the emulated system (system B, in our example) has completed the above steps, a user at the testing system (system A, in our example) can perform compatibility tests in conjunction with a testing system T comprising preferred software. With reference to FIG. 2: the user accesses a server running Certification System software of a preferred embodiment via a user interface 210 (typically a Web browser) to select a test to run. Software of a preferred embodiment maps this selection to a defined Test Script 220, which is a combination of script language program code (such as JavaScript), and user interface presentation definitions (such as HTML page descriptions).

During the running of a test, the Test Script 220 interacts both with the user, and with a Protocol Engine 230. The Protocol Engine is, in turn, connected to the user's communication system 240, for the purpose of testing that protocol link and the business processes that use it.

With a Web browser user interface 210, user interaction is based on dynamically-generated HTML, generated from templates within the Test Script 220.

The Test Script 220 can control and receive event notifications about practically all aspects of the Protocol Engine 230's performance, including, but not limited to:

i) initiating outgoing connections to the user's system 240;

ii) listening for incoming connections from the user's system 240;

iii) transmitting protocol messages back and forth;

iv) managing business processes and data (e.g., matching orders to executions when testing a financial protocol);

v) detecting and handling protocol errors;

vi) deliberately causing protocol errors or non-standard protocol behavior to test the resilience of the user's system 240;

vii) detecting and handling business-level data or process errors (e.g., mismatches between order and execution messages in a financial protocol); and

viii) deliberately causing business-level data or process errors to test the behavior of the user's system 240 in these cases.

States for a typical interactive test are depicted in FIG. 2A.

The appropriate Test Script 220 logs the results of each test in a database 250, indicating whether the test passed, failed, or aborted (failed to complete).

The user, or an administrator, can then review the pass/fail results of tests that have been run, summarizing across a number of dimensions, such as comparing across tests, across users, or across test categories.

In addition, the Test Script 220 can log events for later review. This allows the user, or others, to review the detailed progress of a test to determine and debug why the user's system 240 might have failed a particular test.

More on the Test Script 220: A Test Script provides a flexible programming environment for driving steps of a test, simulating business process logic, and capturing variations in interpretation and implementation of standard communications protocols.

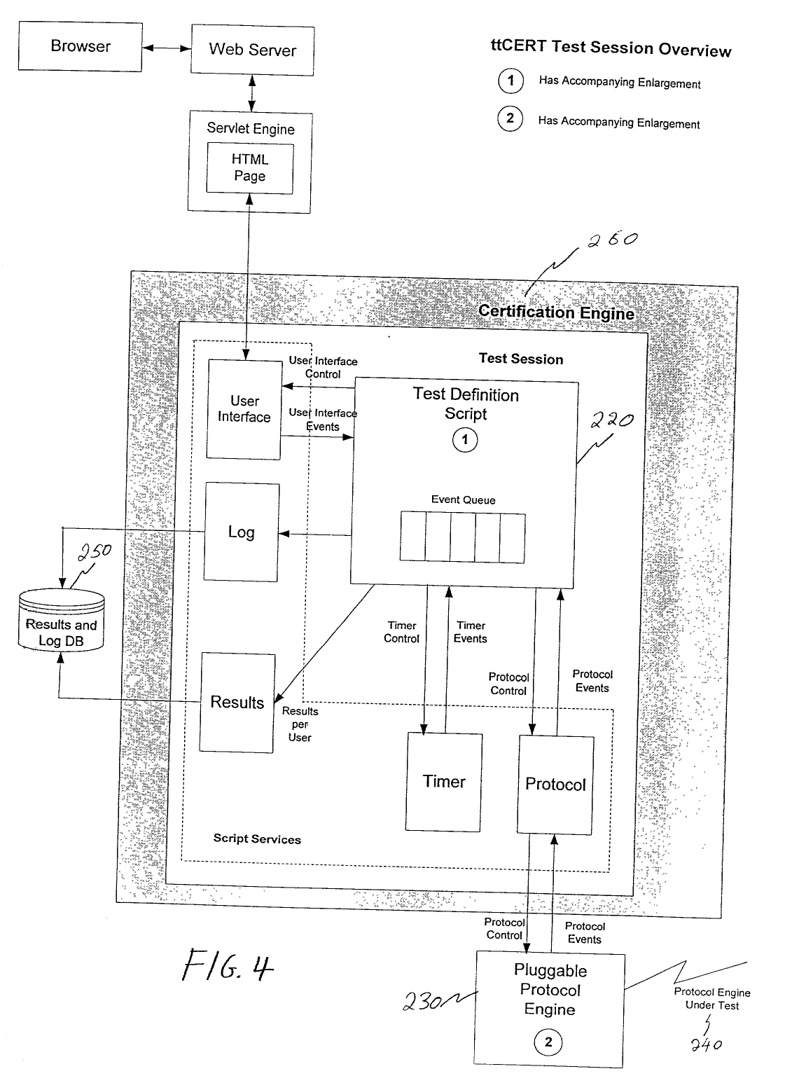

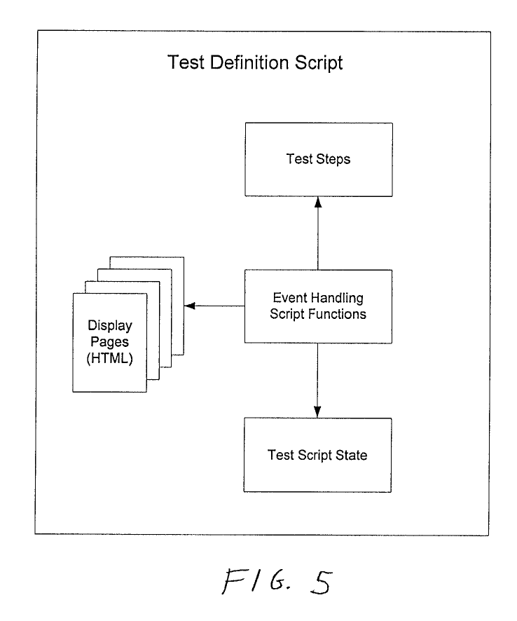

Test Script 220 is preferably an XML document that combines: (a) event-handling software logic written in a scripting programming language such as JavaScript; and (b) definitions for user interface pages that are used by a script to interact with a user. See FIG. 4 and FIG. 5, discussed below. Test Scripts are preferably organized into Test Categories and Test Suites. A test suite defines a list of test scripts available to be run.

Once loaded, a preferred Test Script 220 steps a user through a series of interactions to test a portion of a business process and underlying communication protocol 240. During a test, the Test Script 220 preferably interacts with the user through a presentation interface 210 (e.g., a Web browser), and the user's communication systems 240 via protocol-level connections. The Test Script 220 preferably handles events and controls interactions at both levels. Since the Test Script 220 preferably contains software code in the form of a scripting language, this interaction can be quite sophisticated, and the flow of a test may be as complicated as desired.

In the particular embodiment wherein the tested protocol is the FIX protocol, the following is worth noting: FIX certification scripting differs from many other scripting applications in that the scripts are not simply run from start to end in one shot, and there is no equivalent to a main( ) function. Instead, a FIX certification script is a collection of event handlers—functions that are invoked in response to specific events.

Events may arise as a result of messaging protocol activities (such as connects, disconnects, or the receipt of FIX messages) or user interface activities (such as command and confirmation events that originate from the user controlling the tests).

Event handler functions may or may not take arguments, depending on the event, and they should generally return a boolean value indicating whether the event was handled successfully. Unless otherwise noted, a return value of false indicates to the messaging certification engine that the test should be terminated. If the function does not return a specific value, a value of true is assumed.

Scripts are not required to define handlers for all events. If an event occurs that does not have a defined handler, the event is simply logged and ignored. Examples of event handlers are provided in the following table:

| | |
|---|---|
| onInit() | Called when the test description is first loaded, and before a connection |
| | has been established. This is the first code to be executed in the scripts |
| | and is only called once. This is typically where global script variables |
| | are initialized, a connection is made, or the first web page is displayed. |
| onConnect() | Called when a connection has been established, regardless of whether |
| | the connection originated from the script or from the far end. |
| onDisconnect() | Called when a connection has been dropped, regardless of whether the |
| | connection was dropped from the script or from the far end. |

Results Tracking: once a user finishes a test, the Test Script 220 determines whether the test completed successfully (passed), completed unsuccessfully (failed), or was not completed at all (aborted). Through software of a preferred embodiment, the Test Script 220 can preferably log this result in a database 250, where the result can be combined and summarized with results from other tests.

A preferred software embodiment provides the ability for test results to be summarized for a single user, across multiple users within a company, across categories or Test Suites, or across any other dimension that may be found useful for comparing and tracking the completion of tests.

Event Logging: in addition to the basic test results, any and all events that occur while a test is running can be logged in database 250, for debugging, or to determine why a particular test run succeeded or failed. Events that might be logged by a Test Script 220 in a preferred software environment include: (a) business-level events; and (b) communication-protocol-level events, such as the transmission of protocol messages or the detection of protocol-level errors. The Test Script 220 determines which events are captured and logged.

Automated Testing: since a Test Script 220 is in complete control of stepping through a test, software of a preferred embodiment allows a Test Script 220 to be written to require no user interaction at all. Thus, a Test Script 220 may run one or more tests in a completely automated fashion.

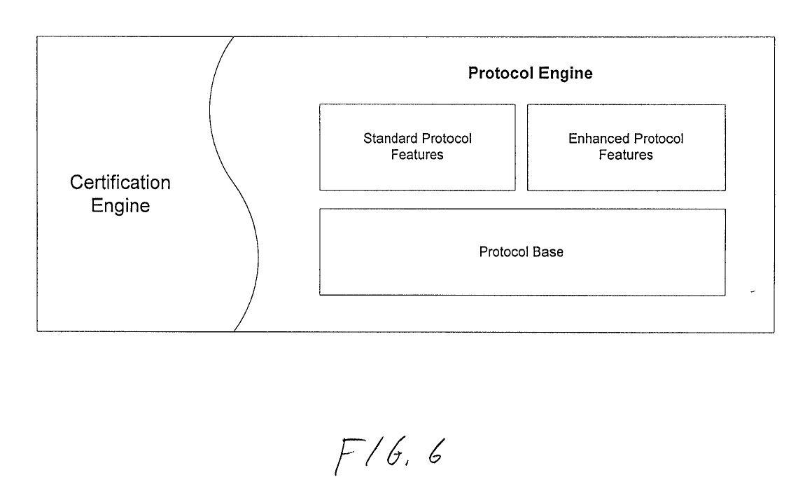

Pluggable Protocol Engine 230 (also referred to herein as protocol drivers): each Test Script preferably interacts with a Protocol Engine 230, which is designed to communicate with a user's protocol communication system 240. See FIG. 4 and FIG. 6. Software of a preferred embodiment supports multiple communications protocols through a Pluggable Protocol Engine interface. Examples of the protocols that a script might interact with include, but are not limited to FIX, SWIFT, FIXML, FPML, and SOAP. Other suitable protocols will be recognized by those skilled in the art.

A preferred feature of a Protocol Engine 230 is the ability to be controlled by Test Scripts 220. This control extends well beyond “out-of-the-box” standardized behavior. It is possible for a Test Script 220 to cause the Protocol Engine 230 to simulate a customized, a “non-standard,” or even a “broken” implementation of a protocol, for the purpose of testing particular protocol installations, or testing boundary conditions.

Preferred Environment: software of a preferred embodiment is designed to be run either by an Internet-based application service provider who hosts tests on behalf of many firms (sometimes referred to herein as “customers”) and their counterparties (sometimes referred to herein as “clients”), or as internal software purchased by a firm and run on the firm's site.

Examples of the advantages and improvements of the present invention over what has previously been done in the art include the following:

Prior art consisted of a manually-intensive testing cycle, typically involving one or more persons at each end of the communications channel interacting with the tests at each step of the process, and interacting with each other via phone and email. Because of the emphasis on manual effort, individual tests ran slowly, and the difficulties of coordinating staff availability at both ends meant that testing was often interrupted and delayed. In addition, test definitions and results tracking were often haphazard and inconsistent due to their manual interaction component.

Using software of a preferred embodiment eliminates the human interaction on one end of the test, and coordinates, streamlines, and minimizes the human interaction on the other end. As a result, individual tests can now be completed much faster. Also, testing may be scheduled based on the availability of a fewer number of people, resulting in fewer delays or interruptions to the completion of a series of tests.

Results tracking is well-defined, consistent, and visible, which dramatically increases the value of the results. Test event logging makes it easier and faster to find and resolve problems in a failed test attempt.

We now describe preferred embodiments of the invention in greater detail.

Test Suite Site Administration:

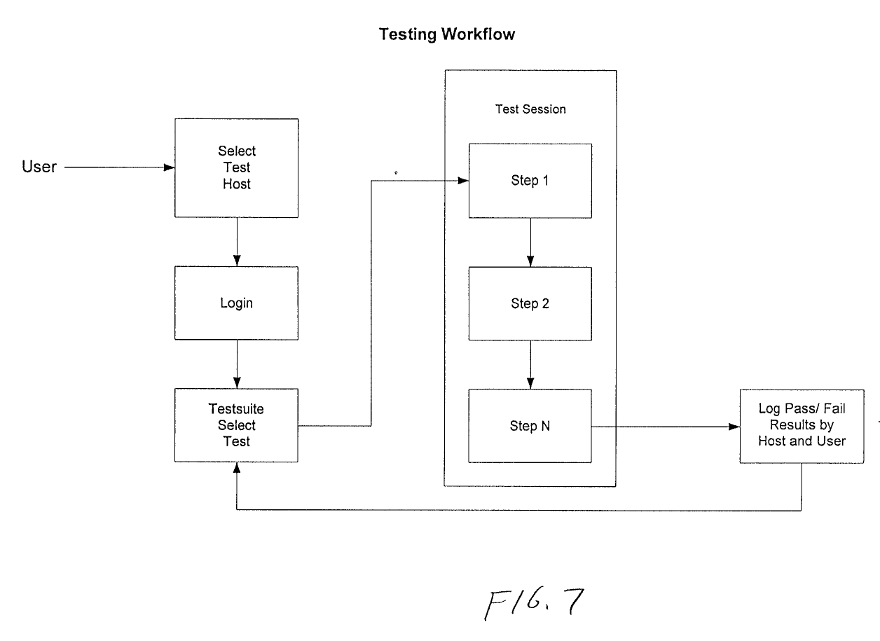

As discussed above, software of preferred embodiments enables a first counterparty (company B, in our running example) to have its trading system emulated, so that a second counterparty (company A) can test its trading system against company B's system. Thus, there are certain steps that are preferably taken by company B to enable the emulation of its system, to enable other companies to access the system that emulates company B's system (also called herein the tested system), and to enable company B to monitor the testing of its emulated system by other companies (testing systems). Those steps, and interfaces preferably used to accomplish them, are described in this section. FIG. 7 provides an overview of preferred testing workflow.

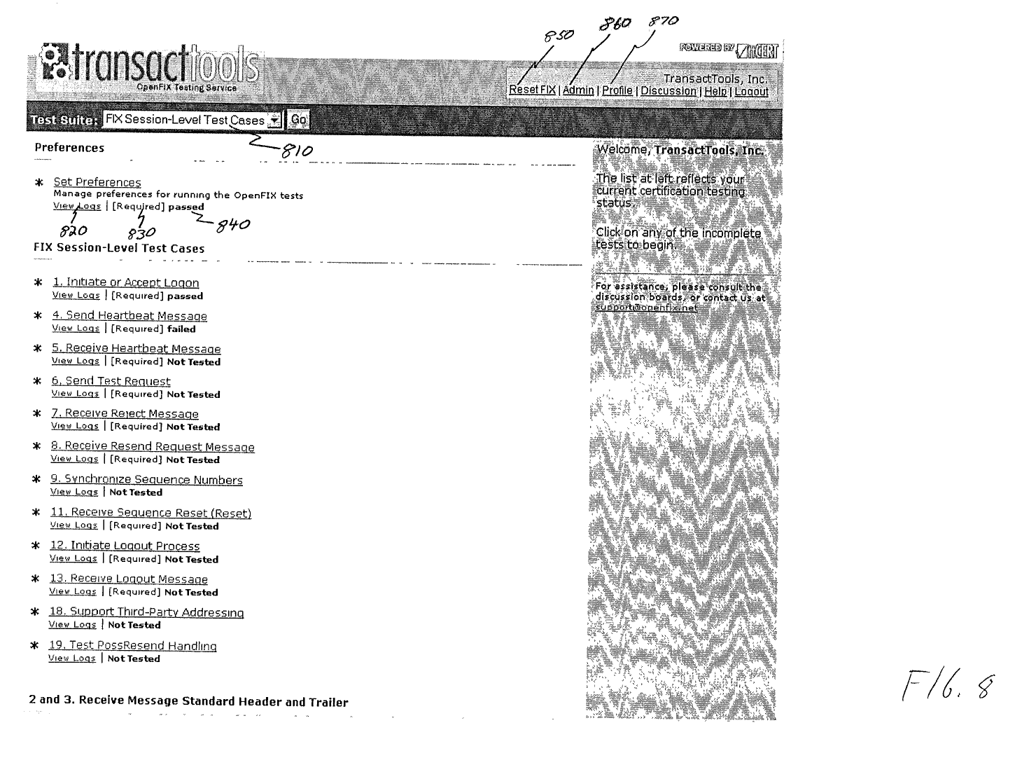

Test suite: A test suite page (see FIG. 8) appears after a successful login by a user of either the tested system or the testing system. If there is more than one test suite, testing users (counterparties) have a list of test suites available in a drop-down menu 810. If there is only one test suite, there is no drop-down list. The test cases that are included in the test suite are listed in the main body of the page.

Beneath the title of each test, there is preferably a link 820 to the logs for that test (View Logs), an indication 830 of whether the test is required, and a testing status indicator 840 (passed, failed, not tested). The logs are used to convey information about previous test runs. Any messages sent, and any other messages generated by the script or the Certification Engine are logged. Note that the terms “Certification Engine” and “ttCert” are used herein essentially interchangeably.

An Admin link 860 is reserved only for users who administer the host site. In a FIX-based embodiment, a Reset FIX link 850 resets the message sequence numbers of the Certification Engine. This could be used if sequence numbers get out of sync between a customer and the Certification Engine, or to simulate the beginning of a new day.

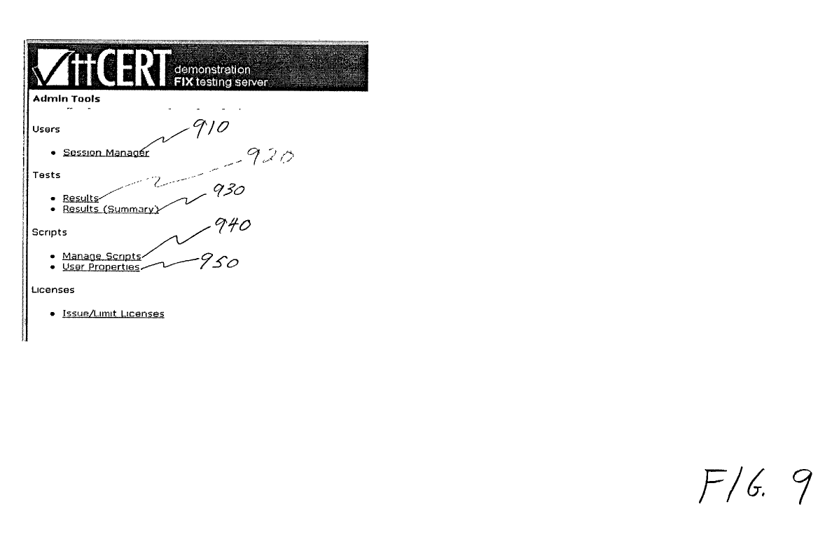

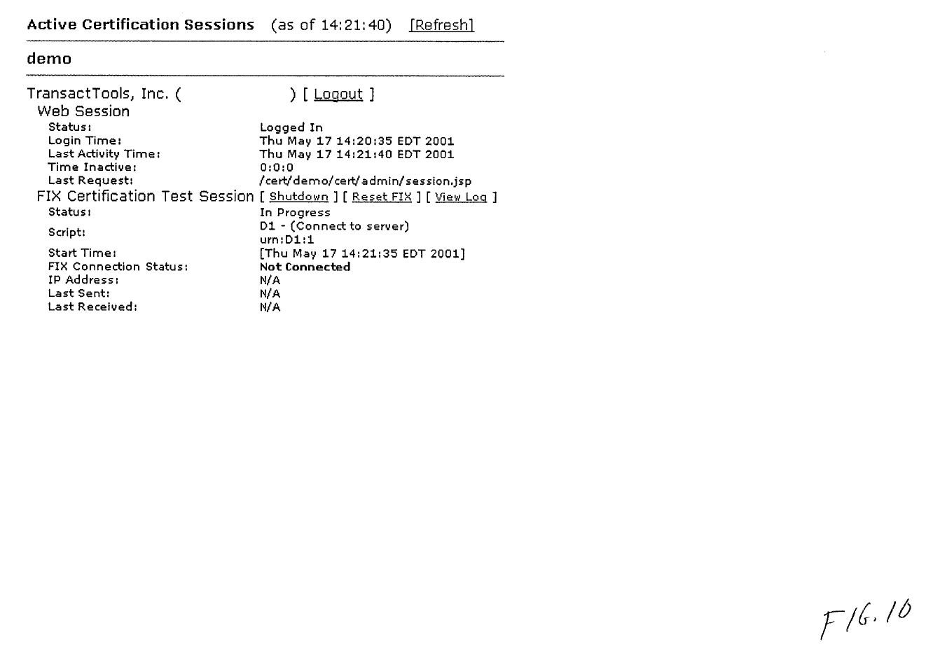

An Admin Tools page (see FIG. 9) provides links to a number of administrative tools. A session manager link 910 leads to a page (see FIG. 10) that provides information about which users are logged in, where they are in the testing process, and also allows tracking of their current testing progress in real-time through the test logs. The session manager provides very detailed information about users logged into the tested system: the last logged message sent or received, what IP address they are connected from, and how long their session has been active. If necessary, users can be logged off, their testing session shutdown, or FIX engine sequence numbers can be reset for them.

A Results link 920 (see FIG. 9) allows a tested (emulated) system user to view clients' (counterparties') testing results on an individual basis, while a Results Summary link 930 lets the user see test results across all testing counterparties.

After selecting the Results link 920, a user is presented with a list of all counterparties that have taken tests in a test suite. The user clicks on a counterparty to view their testing progress. A detailed view is given of what tests have been taken and the most recent outcome of each test: “passed,” “not tested,” or “failed.” By selecting an individual test, the user can view the logs for each time the test was taken.

A Results (Summary) link 930 leads to a view that is useful in determining where counterparties are running into the most trouble. It is also useful to get an overall picture of how many counterparties have been certified and which counterparties are having trouble certifying.

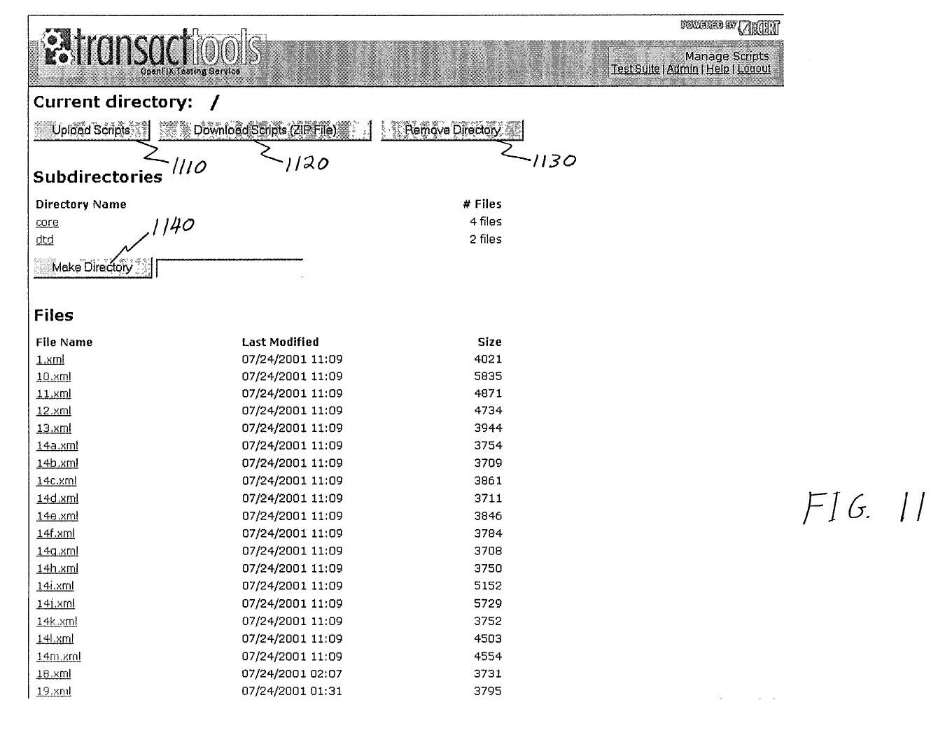

Selecting a Manage Scripts link 940 displays the page depicted in FIG. 11, and provides access to all of the scripts for an emulated system. The top of the page shows the current directory—initially it points to a root directory. Subdirectories available to the user are listed further down the page—in this case, core and dtd subdirectories are shown. Preferred procedures for managing and modifying scripts are discussed below, in the section on Script Writing.

Beneath the Current Directory indicator are three button options: an “Upload Scripts” button 1110, a “Download Scripts (Zip File)” button 1120, and a “Remove Directory” button 1130. The download button 1120 retrieves scripts from the server, and allows the user to place them on the user's local drive. The user can work with these scripts locally, modifying them as needed, and then upload the ones the user wants back to the server.

The core directory contains scripts and documents. The dtd subdirectory contains dtd files for the script XML files. A Make Directory button 1140 allows a user to create a new subdirectory in the user's root directory. The Remove Directory button 1130 permits a user to remove a selected subdirectory.

The rest of the page depicted in FIG. 11 contains a list of the scripts in the current directory. To view a script, a user clicks on it. Once the script is displayed, the user can delete it by clicking a Delete File button.

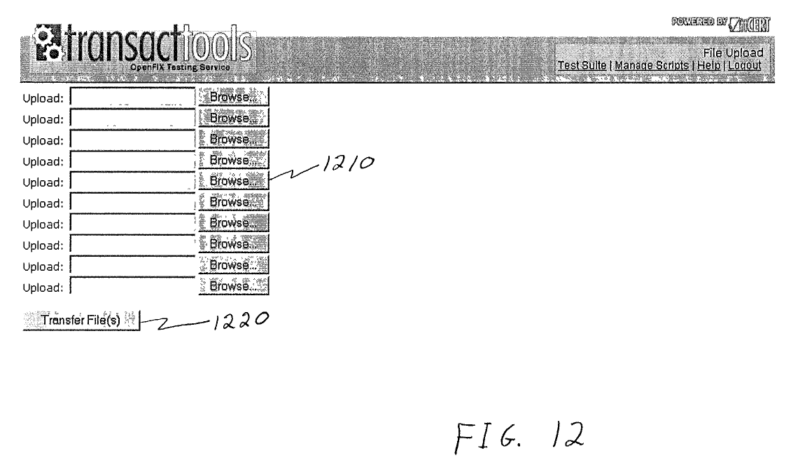

To upload scripts, a user clicks Upload Scripts link 1110, and a page with a list often empty slots is displayed (see FIG. 12). The user clicks a Browse button 1210 next to each slot, locates the script on the user's local computer drive, selects it, and clicks the Open button. The local path to the script will be in the upload list. The user may select as many as ten different scripts at once using the Browse buttons 1210. To proceed with the upload, the user clicks a Transfer File(s) button 1220. For uploading many scripts at once, the script uploader also accepts a zip file that unzips and uploads each script individually.

Selecting a User Properties link 950 (see FIG. 9) displays a page that allows a user to add and edit certain properties that are used by the user's test scripts. A property is a parameter that is passed to the script. It allows a user to declare a global variable, and also to assign a value to it. This variable is referenced and evaluated by code in the script that the user has previously added. This feature allows users to provide additional customization for their testing counterparties.

Script Writing:

This section describes preferred processes for writing and managing scripts.

There are a number of things that a user of a preferred embodiment needs in order to start writing scripts. This list includes, but is not limited to: (1) a test specification; (2) a specification (e.g., a FIX protocol specification); (3) a web browser; (4) a transaction-based application (e.g., an order management system (“OMS”); and (5) a text editor.

Before beginning, it is important to have a copy of the user's test specification available. This document covers the tests that in prior art systems a user would have conducted on the system manually.

In one preferred embodiment, the tested system uses a FIX engine. A FIX test specification (depending on which version of FIX is used) is important for understanding how the core libraries function. Core “create” and “validate” functions are defined by this specification. Although these core functions are provided, the user may add extra functionality to completely capture the behavior of both the user's FIX engine and OMS.

The protocol specification is also important as a reference tool for another reason. Calls to functions in the core libraries and to the Certification Engine are made using naming conventions outlined in the specification.

All scripts preferably can be developed with a simple text editor. To access scripts, a user can go to the Admin Tools menu page (see FIG. 9), click the Manage Scripts link 940. It is recommended that a user set up a local script repository to manage the scripts locally.

To edit a script, a user copies it and pastes it to a text editor.

Editing a Test suite: the test suite and urnmap communicate with the web server to display the appropriate scripts. The preferred layout of a test suite is:

<?xml version=“1.0”?>

<!DOCTYPE certification SYSTEM ‘../tt/testsuite.dtd’>

<certification>

<test suite title=“Test Suite Title” default=“true” resolve=urnmap.xml”>

<category name=“CategoryKey” title=“Category Title”>

<testscript src=“urn:ScriptKey:1”>Script Name

</testscript>

</category>

</test suite>

</certification>

Test Suite Title—this title can be anything desired. A user may have multiple test suites that the user will have to select from in a drop-down menu. A preferred embodiment uses this drop-down menu to separate buy-side and sell-side scripts.

Category Title—the category name could be anything desired. This allows a user to separate categories of tests. For example, some users may wish to separate out different product lines, others to separate out different test types (cancel/replaces, IOIs, session level tests, etc.).

Category Key—the category key cannot contain any spaces, but should be a key for the category. The Certification Engine server preferably uses this when it runs statistics on which counterparties have completed various sections of a test suite.

ScriptKey—the script key correlates with the key in the urnmap. This must be the same name that the user puts in the urnmap and it cannot contain any spaces.

Script Name—the script name appears in the browser when in the index page. This name should be descriptive enough to describe what the test does.

The urnmap has the following layout:

<?xml version=“1.0”?>

<!DOCTYPE ummap SYSTEM ‘../tt/urnmap.dtd’>

<urnmap>

<urn value=“urn: ScriptKey:1”>

<uri value=“Filename”/>

</urn>

</urnmap>

Filename—this is the name of the file, it cannot contain spaces.

ScriptKey—must match the test suite key for a given script, and it cannot contain spaces.

To add a new script, a new entry must be placed in both the urnmap and the test suite following the above layout.

Script Analysis:

This section describes preferred flow of scripts used in a preferred embodiment, using a specific script example, D1 Filled Order Script. This section covers the following topics: (1) Core Libraries; (2) Global Variables; (3) Event Capturing; (4) Capture of Protocol Messages; (5) Capture of Web Page Submissions; (6) Event Handling; (7) Event Processing; and (8) Wizpages. Although specific examples are provided, the term “wizpage” should be understood to refer to scriptable web pages of any type, unless the context of the term dictates otherwise.

The D1 Filled Order is a sell-side script. The Certification Engine Server simulates the role of the sell-side counterparty by receiving orders and sending executions. This role-playing enables the buy-side counterparty to test that its (the buy-side's) FIX engine generates messages that are communicated clearly and correctly. In this context, the Order Management System (OMS) is defined as the system that sends orders and receives executions.

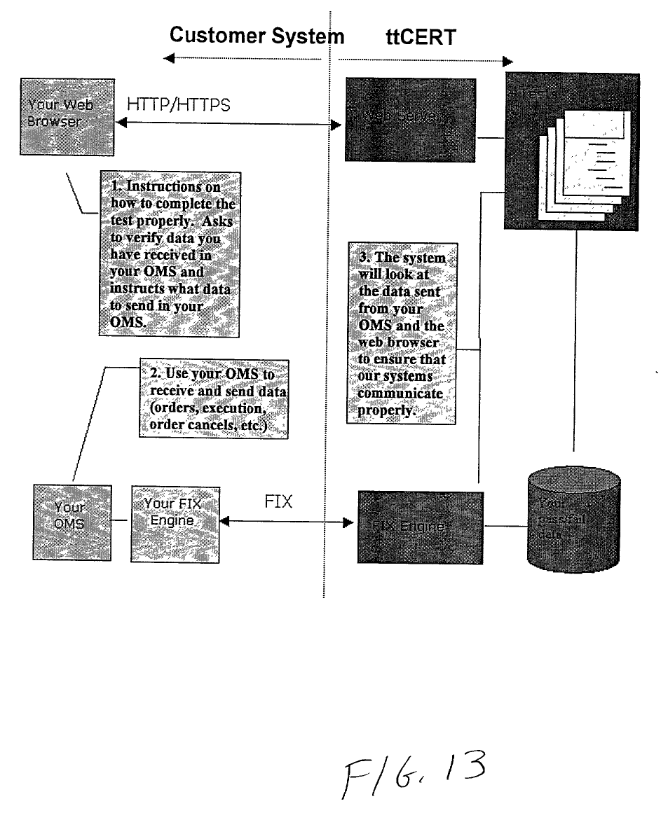

Certification Engine Overview: FIG. 13 provides an overview of how the script that interacts with the Certification Engine's FIX engine, the counter party's FIX engine, and the web browser. In FIG. 13, the scripts are indicated as tests.

Core Libraries: a preferred Certification Engine provides four libraries for commonly used routines. The libraries are not necessary for the operation of the invention. The libraries provide centralized functionality for scripts, containing elements common to many (or all) customers. These libraries are listed below. The host.js library, however, is the only one that can be updated by a user. All the other core library files are “read only” and cannot be changed. Some functions are defined in more than one file. In JavaScript, precedence is important: the last-compiled function definition overrides all other function definitions of the same name. So a user must be sure to include the core files in the same sequence as they are listed below. Functions that are defined within the body of the script, however, take precedence and override any functions defined within the core libraries.

tt.cert.common.js This library contains general routines that are commonly used across all protocol platforms. Date routines, randomization routines, and event-handling routines are included here.

tt.cert.fix.js This library contains routines that use the FIX specification protocol to interact with the Certification Engine and to format FIX message tags. It includes functions that validate incoming FIX messages, and also functions that create and send outgoing FIX messages.

tt.cert.wizpages.js The wizpage library includes routines that generate standard HTML code to produce pages displayed by the web browser. Wizpages capture for view the stages involved when a client-server connection is established, and also the different test states of an order as it is processed. Wizpages are discussed in more detail below.

host.js This library is available for host-specific files that contain any company-specific routines or functionality. The library is provided for a user to write the user's own functions. These can be new functions, or they can be functions that override those provided in another core library. The host.js file will only take precedence when it is included last in the list of included files.

Declaration of Global Variables: Declaring a variable as global, that is, defining it before the body of the script begins, allows that variable to be accessed throughout the different states of the testing cycle. For example, if a variable is declared outside of the processOrder function, which is called when the testing cycle is in the ACKSENT state, that variable can be accessed in the next function verifyExecution, which is called in the PARTIAL1SENT state. In contrast, if a variable is defined within the processOrder function, rather than globally, it cannot be accessed in the function verifyExecution.

The specific test states for a script must be identified. The test state variables are initialized as a sequence of numbers, which are correlated to the order in which each state occurs.

| // States | |
|---|---|
| var ACKSENT | =2; |
| var PARTIAL1SENT | =3; |
| var PARTIAL2SENT | =4; |
| var FILLEDSENT | =7; |

These test states are passed as arguments to functions classified as event capturers and event handlers (discussed below). Sequential numbers could just as easily be used to identify these test states within the script, but to make life easier, these numbers have been set equal to a string that describes the outcome of a state. The numbers themselves are not important—they could be any number between 2 and 98, for example, but the sequence of numbers is important. In the D1 Script, these states correspond to the steps taken to partially fill an order.

The outcome of the first state is the sending of an acknowledgment (“order Ack”) indicating that the order has been received; in the next two states, partial fills (partial executions) are sent, and then, finally, a fill of the remaining shares is sent.

Other states, such as BEGIN_TEST and DONE are defined in the tt.cert.common.js library. All order flow scripts begin with the state BEGIN_TEST and end with DONE. These test states should not be redefined.

The function below creates and populates a test order, which contains the variables OrderQty, Symbol, Price, Side, and OrdType. var order=getTestOrder( );

The data comes from an array of randomly generated orders. The routine for creating this test data is found in tt.cert.fix.js.

To ensure that a particular script runs a specific scenario consistently, order fields may be set to specific values, if desired. For example, using the instruction order. Symbol=“MSFT” sets the symbol to “MSFT” for this particular test. When setting order fields, it is important to use the case-sensitive message tags (such as order.Symbol) exactly as they are used in the FIX specification.

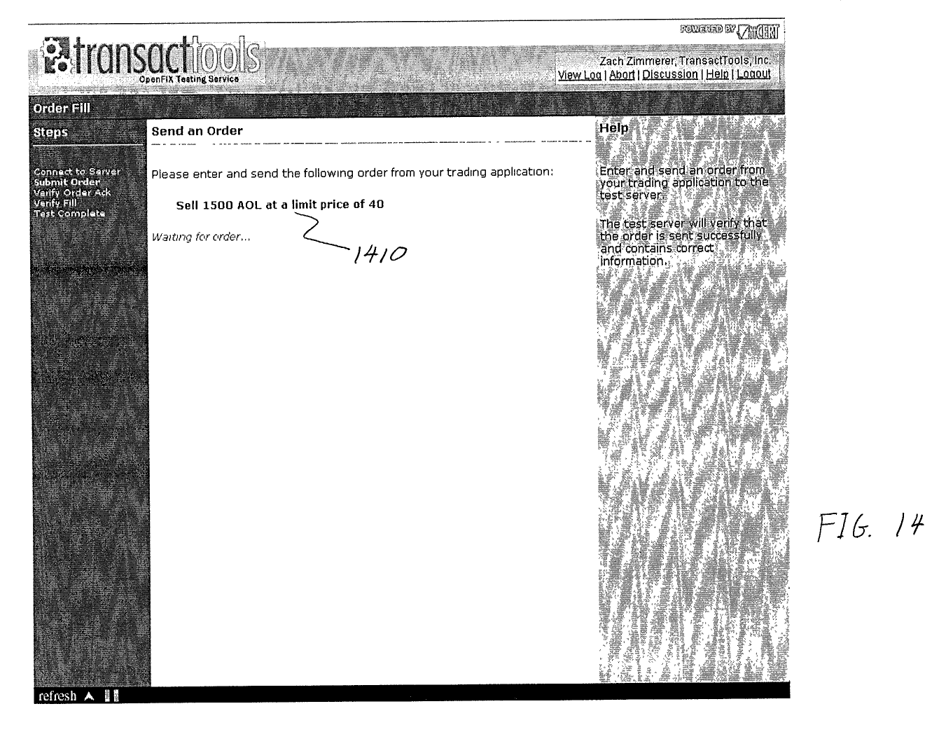

FIG. 14 displays a “connected” wizpage asking for a test order. The populated test order 1410 displayed in FIG. 14 tells the user details of the order to enter into the user's OMS. The function objectToFIXMessage below is used to convert the test order to a FIX message, so that it can be used to validate incoming FIX messages. var testFixMsg=objectToFIXMessage(order);

As with the test order, script-specific fields can be set on the FIX message as well by calling setFieldValue on the FIX message. In the following example, the symbol is set to “MSFT”: testFixMsg.setFieldValue(” Symbol”, “MSFT”);.

It is important that the case-sensitive message tag match the FIX specification exactly when using this function.

The order state object maintains the changing state of the order. By globally keeping track of CumQty, AvgPx, and OrdStatus, a “snapshot” of the order is available at any time. In the following example, cumQty and AvgPx are set to 0, and ordStatus would be set to New:

var orderStateObject=createOrderStateObject( );.

“Initialize connected Wiz page text with data from the test order” instructions format the bold text 1410 in the “Connected” wizpage depicted in FIG. 14. These steps take this information and format it into plain text. They specifically format the order type and price (a limit order at 95, for example) and the order side (buy or sell) with the data from the test order. This order is the incoming order that the Certification Engine server expects to receive. The following code examples demonstrate how to set up the text for the “Connected” wizpage.

| | |
|---|---|
| var orderTypeText | =getTestTypeText(order.OrdType, order.Price); |
| var orderSideText | =fieldValueMap[“Side”][order.Side]; |

Verification arrays determine what fields the browser will ask the user to verify. For example, if an array has the fields LastShares and LastPx, the wizpage will ask the user to verify that this is information that appears in the user's OMS. An empty array, or no array at all, prompts the user to acknowledge whether the expected message was received. The user will be given a yes or no response option. The following examples show possible verification arrays:

| | |
|---|---|
| var fldsPartial1 | =new Array(“LastShares”, “LastPx”); |
| var fldsPartial2 | =new Array(“CumQty”); |
| var fldsFilled | =new Array(“LastPx”); |

These arrays are used in two locations, the verify function and the wizpage call, as follows: verifyWWWParams(“1st Partial Fill”, outboundMsg, fldsPartial1)

<%=partial I VerifyPageBody(fldsPartial1) %>

It is important that the fields match the tags from the FIX spec exactly.

“Initialize fill sequence” instructions establish the fill sequence (partial execution sequence) in a particular test:

var fills=new Object( );

fills=getTestFills(fills,testFixMsg,3);

The function getTestFills generates a random number of shares for each desired fill and attempts to improve the price on each fill. It improves the price by setting LastPx equal to a random amount, just a little bit better than the Price. For example, if getTestFills is set to 3 fills, it returns 3 improved prices (LastPx) and 3 fill quantities (LastShares), with the total quantity of all shares equal to the original order quantity.

The following function appears in the body of the D1 script, and shows how the array elements fills.qty and fills.px are used to create an order fill:

outboundMsg=createOrderFill(originalOrder, orderStateObject, fills[1].qty, fills[1].px);

The fields originalOrder and outboundMsg need to be declared outside the body of the script, so that they can serve as global variables to pass the incoming messages from state to state throughout the execution of the script. These are declared and initialized to null before the body of the script starts, because at that point no incoming messages have been received yet.

var originalOrder=null;
var outboundMsg=null;

The following instruction shows where the incoming order (fixMsg) is stored, so that it can be accessed later if necessary. This code example is found in the function

“processOrder” in the D1 script:

originalOrder=fixMsg;

A global variable is also necessary to store the outgoing message, so that it can be accessed in the next state to verify the fields that the user enters.

In the following code the order acknowledgment (“orderAck” sent by the user) is saved in the outbound message, and then accessed by a function receiving it as a parameter during the next test state:

outboundMsg=createOrderAck(originalOrder,orderStateObject);

verifyWWWParams(“1st Partial Fill”, outboundMsg, fldsPartial1)

An event (within the Certification Engine context) is defined as either of these two actions: (1) a submitted web page; or (2) an incoming FIX message.

Event capturers are functions that are used to indicate that an event has occurred. While any incoming FIX message or browser-input submission can be captured, only those that have defined event capturers are actually recognized by the scripts.

Once an event has been captured, it is passed to either handleMessage or handleEvent, which calls up the event handler for the appropriate state. An event handler (defined below) invokes an event processor (event-processing routine, also defined below), the function that processes the message.

Thus the preferred sequence is Event Capture→Event Handling→Event Processing. There are two distinct ways to capture an event, depending upon what type of event it is.

For retrieving data entered from a web browser, there is an event capturer in the core library tt.cert.fix.js, which is named onlncomingWWWParams. This function calls handleEvent, which grabs the appropriate event handler, depending on the current state. It passes all user-entered input by way of a global variable defined in the Certification Engine Server to the appropriate processing function. To make a user-submitted page an actual event recognized by the script, it must be called from the wizpage as in the following example:

<wizpage name=“AckSent” submit=“onlncomingWWWParams” stepld=“3”>

When the user clicks “OK” or “YES” in this web page, the process becomes an event recognized by the script and the user's input is passed to the processing function. In this case, the processing function is verifyPartial1.

The other type of event to capture is an incoming FIX message. All incoming FIX messages are captured but do not actually become events until handleMessage is called. In the following code, D1 turns the incoming order received during the BEGIN_TEST state into an event.

function onlncomingOrderMessage(fixMsg) {

return handleMessage(fixMsg, BEGIN_TEST);

}

onIncomingOrderMessage passes the expected current state of the message and the captured message to handleMessage, which ensures that the script is in the expected state. If an order is sent and the state is not BEGIN_TEST, then an error is produced. To call any other event capturer, use onIncoming/OutgoingXXXMessage, where XXX is a message type defined in the FIX protocol.

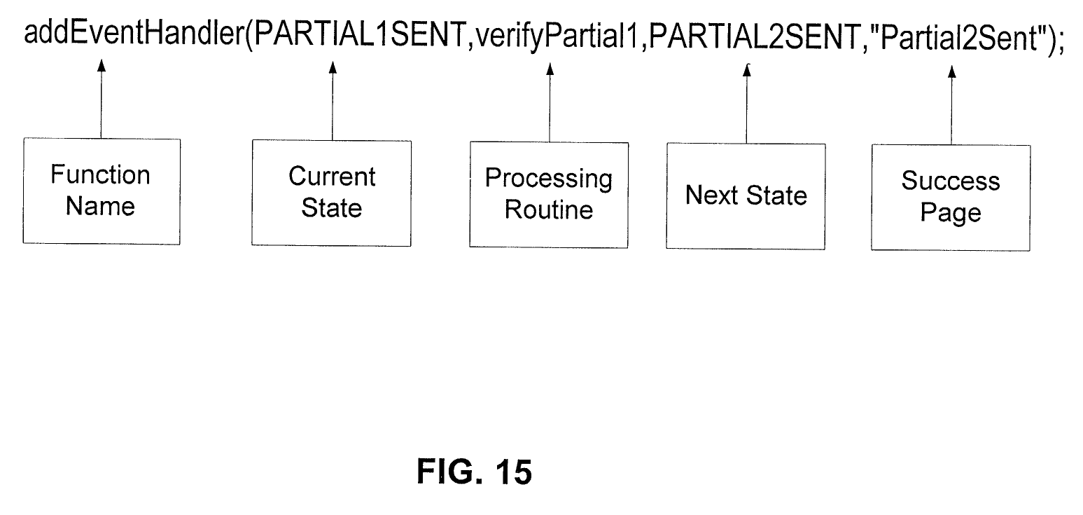

An event handler is a function that controls the flow of the script by linking one test state to the next. It also links the current state to the processing routine that handles that state. An event handler contains four parameters essential to the flow of the script. As shown in FIG. 15, these parameters contain the current state, the processing routine that is linked to the current state, the next state, and the “success” page.

Once an event is captured, the event handler for the current state is called—that is, the event handler with the first parameter equal to the current state. Once called, the event handler invokes a processing routine, passing to that routine whatever data was captured. If this processing routine returns TRUE, then the event handler sets the next state and displays a success wizpage.

By looking at the event handlers, a user, and those skilled in the art will be able to tell what the expected sequence of events will be. Looking at the D1 Script event handlers shown below, it should be clear that an order is received from the buy-side partner, an acknowledgment (an “ACK”) of the order is sent back to the buy-side partner, two partial fills (partial executions) are sent, and then a final fill of the remaining shares is sent.

addEventHandler(BEGIN_TEST,processOrder,ACKSENT,”AckSent”);

addEventHandler(ACKSENT,verifyExecution,PARTIAL1SENT,”Partial1Sent”);

addEventHandler(PARTIAL1SENT,verifyPartial1,PARTIAL2SENT,“Partial2Sent”);

addEventHandler(PARTIAL2SENT,verifyPartial2,FILLEDSENT,“FinalFillSent”);

addEventHandler(FILLEDSENT,verifyFill,DONE,”Test Complete”);

Note that the next-event state of one handler is the first-event state of the handler after it. This is how processing moves from one state to the next.

The test-state names and processing-routine names cannot contain spaces or special characters. The “success “page is a string, however, marked by quotation marks. This last parameter can contain spaces, but should be the same string that is used as the wizpage name. Other than the first state, BEGIN_TEST, and the last state, DONE, the states should be the same states that were initialized in the beginning of the script. The states BEGIN_TEST and DONE are defined in the core library tt.cert.common.js.

Event-processing routines make up most of the script body and handle most of the script's functionality. They invoke functions that manage these tasks: (1) validating a FIX message or verifying user-submitted input from a wizpage; (2) creating a new message; and (3) sending a message.

An incoming FIX message needs to be validated against the FIX protocol specification. Most validation routines are part of the tt.cert.fix.js core library, and these focus on handling a specific type of transaction validation, such as the validation of an order (function validateOrder) or the validation of a cancel message (validateOrderCancelRequest).

The sample code below shows the incoming order fixMsg being compared to the testFixMsg. (The testFixMsg variable was initialized at the start of the script to contain the test order).

if (validateOrder(fixMsg,testFixMsg)) {

The incoming fixMsg order should be identical to the saved testFixMsg, except for the addition by the user of the client order Id (clOrdId) to the fixMsg. Once an order has been validated, it is logged, as shown in the example below.

logMsg(“Incoming order validated.”);

In the D1 Script, FIX validation only occurs once—only one inbound fixMsg, with the client order Id, is received during the course of a testing cycle. All other actions against this order are received through user submissions through the web pages. This scenario, however, may not always be the case in every script. For other types of tests, (such as a cancel/replace transaction) the testing scenario may require more than one inbound FIX message.

In contrast to the way FIX validation is handled, data entered through a web page is verified using a single core function: verifyWWWParams.

if (verifyWWWParams(“1st Partial Fill”, outboundMsg, fldspartial1))

The function verifyWWWParams takes from one to three parameters, and is defined in the tt.cert.fix.js library. The first parameter indicates the order state within the testing cycle—in this case, the first partial execution of the order is underway (“1st Partial Fill”). If the function completes successfully, this string is appended to the comment “verified” and logged to record the progress of the script.

The second parameter contains the previous outbound message sent by the Certification Engine to the user. The third parameter says what information is to be verified by the users for the first partial execution. In this case, the variable fldspartial1 is an array that indicates that “LastShares” and “LastPx” need to be displayed and verified on the wizpage.

The data that the user submits from the wizpage is captured in a global variable array, which is available to the scripts, but declared within the Certification Engine server. Passing data in this global variable is handled through a Java API (Application Program Interface), which intercepts calls between the scripts and the Certification Engine engine.

Once an incoming fixMsg with the client order Id (ClOrdID) has been validated, that message is saved, and used to create the next outbound order.

originalOrder=fixMsg;

This saved message, originalOrder, is passed to routines that take an action against the order, and which create a new outbound FIX message. In the D1 Script, these actions are the partial executions against the original order. The orderStateObject maintains the updates to cumQty, AvgPx, and ordStatus, so that the dynamic state of the order is always known. Before partial fills of the order are executed in D1, however, an order acknowledgment is created in outboungMsg. The code example below shows the creation of an outbound message acknowledging the receipt of an order.

outboundMsg=createOrderAck(originalOrder,orderStateObject);

Once a new message has been created, it is passed to the routine sendFIXMessage. This routine accepts two parameters: the message, and a string indicating what type of message it is. The progress of the script is logged using the second parameter. In the following D1 example, an order acknowledgment (“ord ACK”) is being sent:

sendFIXMessage(outboundMsg,”Order Ack”);

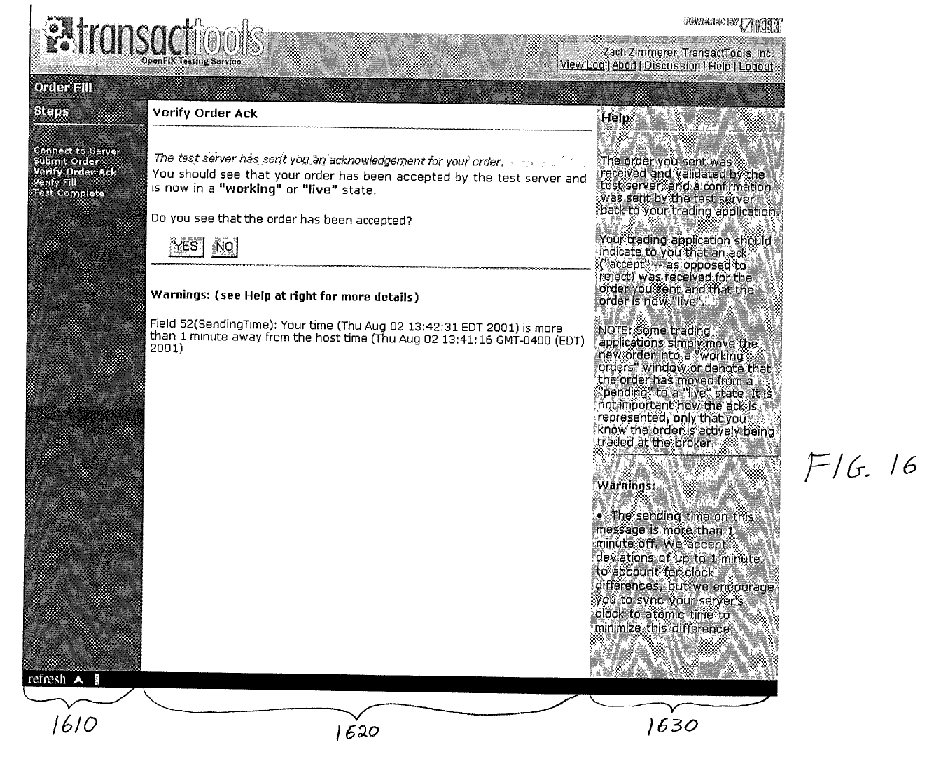

A wizpage is a way for the script to communicate with the user through the web browser. In a preferred embodiment, Certification Engine wizpages (see FIG. 16) are formatted into three frames: (1) a Steps Column 1610; (2) a Page Body 1620; and (3) a Help Column 1630.

The Steps Column 1610 shows the step progression—the highlighted step indicates where the viewer is in the overall progress of the script.

The Page Body 1620 displays prompts to help the viewer complete the appropriate steps through a testing cycle.

The Help Column 1630 provides an in-depth description of what is going on in the script and instructions about how to complete the test.

Wizpages are preferably written in XML, rather than JavaScript. A typical wizpage may look like this example of an “order Ack” wizpage from the D1 Filled Order Script:

<wizpage name=“AckSent” submit=“onlncomingWWWParams” stepld=“3”>

<title>Verify Order Ack</title>

<help>

<![CDATA[

<%=executionVerifyPageHelp( ) %>

]]>

</help>

<body>

<![CDATA[

<%=executionVerifyPageBody( ) %>

]]>

</body>

</wizpage>

This example sets up the wizpage Help and the wizpage body between the <help></help>and <body></body>tags, respectively. These sections invoke functions in the tt.cert.wizpages.js core library.

Some other important fields to note are the following:

Wizpage Name: name=“AckSent”. This field needs to match the tag used in the event handler. It does not actually appear anywhere in the web page. submit: submit=“onlncomingWWWParams”. This field indicates which event capturer is invoked when the user submits a page. If no submit step is included in a wizpage, then the Certification Engine sleeps until an incoming message is captured instead. The “Connected”, “Welcome”, “Error”, “Disconnected”, and “Test Complete” pages are called from the core libraries, and do not require a submit field.

stepId: stepld=“3”. This is the stepID=“XXX” field. This field is used to show the current step. Some steps do not have step IDs if it is uncertain whether they will be called. For example, the “Disconnected” page, which is called from the core library, does not have a step ID.

page title: <title>Verify Order Ack</title>. The page title can be anything that the scriptwriter chooses. This title is displayed in the wizpage body.

To set up the final section, the step ID portion of the wizpage, we need to correlate the step IDs that were declared to what is to be shown in the browser. Each step ID is identified by a string:

<step id=“1”>Connect to server</step>

<step id=“2”>Submit Order</step>

<step id=“3”>Verify Order Ack</step>

<step id=“4”>Receive First Fill</step>

<step id=“5”>Receive Second Fill</step>

<step id=“6”>Receive Final Fill</step>

Automating Sell-side Interactive Scripts:

An automated sell-side script is a script that runs with minimal web-browser interaction. After the script is initialized, it waits to receive a message (an event) from some other source, such as another script or a FIX engine. Once the process has started, all processing takes place in the background until the “Test Complete” page is shown.

Automated tests are useful when a user would like to: (1) run against a buy-side script; (2) test the user's own scripts, but the user doesn't want to either hook up an OMS, or walk through each test, step-by-step, manually entering and verifying data through the browser.

With a few exceptions, these scripts are written in the same manner as the interactive scripts. In fact, they are so similar that it requires only a few conversions to the interactive scripts to automate them.

The first step in creating either an interactive or an automated script in a preferred embodiment is to add the script to both the urnmap.xml and testsuite.xml. An automated script must be marked as “automated”, however. See the examples below for how to mark the ScriptKey:

<urn value=“urn:automated:ScriptKey:1”>

<testscript src=“urn:automated:ScriptKey:1”>

Marking the ScriptKey as “automated” in the test suite and in the urnmap sets a global variable AUTOMATED_MODE to TRUE for the scripts. For a single script to run as both automated and interactive in the same test suite, it must have two entries in each file: an entry as an interactive script and an entry marking it as an automated script.

The next step in converting an interactive script into an automated one is to add event handlers for automated processing. Use the global variable AUTOMATED_MODE as a flag to determine if automated processing is required. When automated mode is TRUE, add the event handlers that point to routines for automated processing; when not TRUE, allow control to pass to the event-handler routines for interactive processing.

Unlike an interactive script, which has event handlers for both incoming browser messages and incoming FIX messages, the automated script only has event handlers for test states that expect an incoming FIX message. Once an incoming FIX message arrives, an event is triggered, and all the processing takes place in the background. An incoming order or an incoming cancel could trigger the processing. The following code is an example of an event handler (for automated processing) that only expects an incoming order:

if (AUTOMATED_MODE) {
addEventHandler(BEGIN_TEST,processOrder,DONE,“Test Complete”);
} else {
all interactive event handlers...
}
In automated processing, fewer incoming FIX messages translates into fewer events.
More outgoing FIX messages are therefore generated and sent within an event. For example,
in the D1 script, the order acknowledgment “order Ack” and all partial fills from the
BEGIN_TEST state are sequentially sent as follows:
function processOrder(fixMsg) {

if (validateOrder(fixMsg,testFixMsg)) {

logMsg(“Incoming order validated.”);
originalOrder = fixMsg;

outboundMsg = createOrderAck(originalOrder,orderStateObject);

sendFIX(Message(outboundMsg,“Order Ack”);
if (AUTOMATED_MODE) {

outboundMsg = createOrderFill(originalOrder, orderStateObject, fills[0].qty,
fills[0].px);

sendFIXMessage(outboundMsg,“1st Partial”);
outboundMsg = createOrderFill(originalOrder,

orderStateObject, fills[1].qty,
fills[1].px);

sendFIXMessage(outboundMsg,“2nd Partial”);
outboundMsg = createOrderFill(originalOrder,

orderStateObject, fills[2].qty,
fills[2].px);

sendFIXMessage(outboundMsg,“Final Fill”);
}

return true;

}

else {return false;}
}

The last step in creating an automated script is to add a wizpage for the time periods when the test is running in automated mode. Simply include a new wizpage called “RunningTest”. All event states, other than DONE, (Welcome, Connect, Error and Disconnect) use this wizpage rather than the interactive wizpages. The “RunningTest” wizpage does not have a Steps column, and is not added to the step list, because it is called for all other states. The test progress is not displayed to the user until an awaiting message state is reached. The “RunningTest” wizpage generally looks like the following:

<wizpage name=“RunningTest”>

<title>Running Test</title>

<help>

<![CDATA[

<%=runningTestPageHelp( ) %>

]]>

</help>

<body>

<![CDATA[

<%=runningTestPageBody(“Testing in Automated Mode...”) %>

]]>

</body>

</wizpage>

Writing Buy-side Order-flow Scripts:

Just as a sell-side script imitates the FIX engine of a sell-side firm, a buy-side script imitates the FIX engine of a buy-side firm. Instead of receiving orders and sending executions, the buy-side script sends orders and receives executions. Although the two types of scripts are very similar, there are a few exceptions worth mentioning, and they are listed below.

(1) The buy-side script initiates the connection. Although sell-side scripts sometimes initiate connections, the buy-side script usually initiates a connection. To initiate a connection, a user needs to make sure that the user's company profile has a port associated with it for the FIX engine the user is trying to connect to.

(2) The number of execution reports to be received is not known in advance. With a buy-side script, it is not possible to know in advance how many transaction reports will be received after an order is placed. One way to handle this unknown is to wait for all executions until the order is filled (i.e., until the CumQty is equal to the OrderQty). The following code example shows an event capturer for this scenario:

function onIncomingExecutionReportMessage(fixMsg) {

//if this is a complete fill, move to last state before completed if (fixMsg.getFieldNumberValue(“CumQty”) ==originalOrder.getFieldNumberValue(“OrderQty”)) {

state=AWAITING_FILL;

}

return handleMessage(fixMsg, state);

}

Note that once the order is completely filled, a user needs to manually set the state to AWAITING_FILL to proceed on to the next step.

(3) No user input is required. No user input verification steps are necessary in a buy-side script. In a buy-side test, executions are automatically sent from the FIX engine or sell-side script; in many cases this will happen very quickly. This rapid response makes it unfeasible to try to verify order fields from execution to execution, because the test will have moved on to the next step by the time the user is able to key in the information seen in the OMS.

A common use of a buy-side script is to run it against a sell-side script, rather than a FIX engine. In this situation, the buy-side script is easier to write because a user knows exactly how many executions will be received and in what order to expect them. This allows the user to check each message received in a linear fashion, much as one would do with a sell-side script. However, because the sell-side script tries to validate the orders, cancels, and cancel/replaces that are sent to it, the buy-side script needs to send exactly what the sell-side script expects. For example, if the sell-side script expects to receive a market sell on 2000 MSFT, the buy-side script needs to be sure to send that. A preferred way to handle this requirement is to hard-code the orders into the scripts. Additionally, when running the buy-side script with the sell-side, the sell-side script should be in automated mode.

Customizing Scripts:

Scripts can be customized by a user for an emulated system site by identifying and adding the specific behavior of a FIX engine to the scripts. This allows the user to configure the Certification Engine to behave exactly as the FIX engine at the user's site behaves for every scenario and for every message type.

Specific or unique behavior can be defined as: (1) unique messages that are sent in particular circumstances; and (2) unique message fields and tags that are located on particular message types.

The following five steps can be used to add the behavior of a user's particular FIX engine to a script.

(1) Determine the behavior of the user's FIX engine. To determine the behavior of the user's FIX engine, the user needs to have an order management system (OMS) available that is capable of simulating a counter party. Using this OMS, the user runs each test in the user's test specification against the user's FIX engine and logs the input and output results. It is important to capture a snapshot of all the raw FIX messages that are generated as a result of the test script. The easiest way to do this is to use an OMS that logs the results.

(2) Parse the logged results. Once all the message types have been logged, a user can view the testing logs with a text editor. There are programs available that can convert FIX message tags to text (which is preferable to reading raw tag-value pairs). In the logs, the user finds each message type and looks at what FIX field tags and values are sent by the user's FIX engine. In many cases, these will differ slightly from the default message tags and values. For example, the Certification Engine may send back an OrderID, tag 37, in the format “xxxxxxxx-x”, while the user's FIX engine may simply send back “x”.

Additionally, a user should check whether the user's systems exhibit behavior that the user wishes to duplicate in the user's certification scripts. For example, if a heartbeat message is sent after every 10 execution reports (regardless of the user's system heartbeat interval), the user will want to do the same in the user's scripts to make sure that counter parties can handle that behavior.

(3) Add any unique message tags and values to FIX messages. Once a user has identified how the user's FIX engine formats messages, the user is ready to add that behavior to the host.js file. To do this, the user opens the host.js file in a text editor. Now the user can override the postCreateXXX and postValidateXXX core library function calls. By default, these calls do nothing. For example, if the user's system sends back an order acknowledgment message with field number “9000” equal to “Y”, the user would do the following:

function postCreateOrderAck(orderAck,fixMsg) {

orderAck.setFieldValue(“9000”, “Y”);

return orderAck;

Once the user has made this change, all order acknowledgments will send field 9000=Y. If one particular script acts differently and needs to format one message in a very specific way (which differs from the user's standard “post” method for some reason), the user could make the change directly to that script as follows:

someMessage=createOrderAck(someMessage, orderState);

someMessage.setFieldValue(“9000”,”Y”);

(4) Add unique messages for particular circumstances. In some circumstances, a user's FIX engine may send back a message that is completely different from the standard behavior of the Certification Engine. In these cases, the user will have to add this behavior directly to the scripts. For example, if the user's engine sends a test request after any string of executions, the user will need to implement this by changing the scripts that send a string of executions. After the last execution, the user will have to create and send a test request in the script itself.

(5) Add customized wizpages. In many cases, a user's engine may have behavior that the user would like to explain to counterparties via the web page. When this is the case, the user should overwrite the standard wizpage calls to functions in the core library tt.cert.wizpages.js. These overrides can be done in the user's host.js file the same way they are done with the postXXX calls. For example, if the user's system sends back an “order Ack” with field “9000” set to “Y”, the user may want to warn counterparties about it, or even provide an explanation about why the user's engine behaves this way.

Session-level Scripting:

To round out a good test suite, several session-level scripts are usually required. Even though a session-level test is structured in a way that is similar to that of an order-flow test, putting together a session-level test requires a greater understanding of the scripting process. A preferred test matrix is provided below.

Unlike order-flow tests, session-level tests often require overriding some of the core event handlers, such as the handlers for the INIT and CONNECTED states. For example, when developing a test requiring a logon from a client user, one must ensure that the test forces the user to logon. Once the user is already logged on, however, the core libraries lead immediately to the CONNECTED state. The following event handlers show how to override this process in the core libraries:

addEventHandler(INIT,connected,CONNECTED,“Welcome”);

addEventHandler(CONNECTED,validatelncomingLogonMessage,DONE,“TestComplete”);

Here, we haven't even made it to the state BEGIN_TEST, which follows CONNECTED in a typical order-flow test. Instead, we have validated the incoming logon message. To gain access to these states, we will also have to override our core event capturers onInit( ) and onDisconnect( ) and onIncomingLogonMessage(fixMsg), as we do in the next step.

Furthermore, unlike application-level tests, session-level tests often have several possible paths to completion. The event handlers should represent the minimum required to complete the test, but you may need to use other event capturers to handle the optional events.

For example, when the server stops sending heartbeats, the client is required to disconnect:

addEventHandler(BEGIN_TEST,beginTest,STOPPED_HEARTBEATS,“RunningTest”);

addEventHandler(STOPPED_HEARTBEATS,processDisconnect,DONE,“Test Complete”);

However, the client may send a test request to determine whether the server is still alive, and may also choose to send a logout before disconnecting. A user would need to implement onIncomingTestRequestMessage(fixMsg) and onIncomingLogoutMessage(fixMsg) to validate these correctly.

The most important aspect of writing a session-level test is using the event capturers wisely; they are very powerful for these tests. In the most standard cases, our core event capturers return false, indicating to the engine that our script did not handle the message. However, if we return true from an event capturer, we are indicating to our engine that we handled it in the script, so it should do nothing. For example, if we return true from the event capturer onIncomingLogonMessage(fixMsg), the engine will not send an outgoing logon message. Continuing with our logon example above, we want to force the client to logon for this test, so we override the core onInit( ) function by rewriting it in the script; this forces the engine to disconnect if the client is already connected:

function onInit() {

setHostValues();
if(fix.isConnected()) {

fix.disconnect();
user.setSessionProperty(“FIX_LOGON”,“N”);

}
fix.awaitConnection();
return newState(INIT, “Welcome”);

}
When doing this, we are also going to have to override the core function
onDisconnect() to avoid an error. We handle this in the following example. Notice that if the
state is null we return TRUE, and the engine does nothing:
function onDisconnect() {

if (fatalError) {

return true;

}
if (state != null) {

result = FAILED;
logErrorMsg(“Disconnect occurred unexpectedly.”);
www.showPage(“Disconnected”);
www.exitFailure();

} else {

logMsg(“Disconnected”);

return true;
}

}
The next step to complete the example is capturing the logon message, allowing us to
validate the logon, and then to proceed to the next state. If we did not capture the logon
message as we do below, there would be nothing to make the engine proceed to the next state:

function onIncomingLogonMessage(fixMsg) {

if (state == CONNECTED) {

return !handleInboundMessage(fixMsg, CONNECTED);

}

else {

return !handleEvent();

}

}

Session-Level Test-Case Matrix:
ttSession Level - Incoming Sequence Number Too Low

| | Receiving | Sending | | |
|---|---|---|---|---|
| Time | Action | Action | Condition/Stimulus | Comments |
| 1 | Any | | | Receive message with expected |
| | Message | | | incoming sequence number (N), |
| | | | | simulate incoming expected |
| | | | | sequence number too low by |
| | | | | calibrating expected incoming |
| | | | | sequence number to (N + X). |
| 2 | Any | | | Incoming sequence number (N + 1) |
| | Message | | | is (X − 1) lower than expected. |
| 3 | | Send | Incoming sequence | Incoming sequence number too |
| | | Logout | number too low. | low. Client should be able to |
| | | | | verify logout and disconnect. |

ttSession Level - Incoming Sequence Number Too High

| | Receiving | Sending | | |
|---|---|---|---|---|
| Time | Action | Action | Condition/Stimulus | Comments |
| 1 | Heartbeat | | | Receive message with expected |
| | Message | | | incoming sequence number (N), |
| | | | | simulate incoming expected |
| | | | | sequence number too high by |
| | | | | calibrating expected incoming |
| | | | | sequence number to (N − X). |
| 2 | Heartbeat | | | Incoming sequence number (N + 1) |
| | Message | | | is (X − 1) higher than expected. |
| 3 | | Send | Incoming sequence | |
| | | Resend | number too high. | |
| | | Request | | |
| 4 | Sequence | | | Since the skipped messages are |
| | Reset- | | | administrative messages, they |
| | Gap Fill | | | should not be resent. Instead, |
| | | | | ensure that Gap Fill has possdup |
| | | | | set to Y and that the sequence |
| | | | | number is 1 greater than the last |
| | | | | message received. Other |
| | | | | acceptable, but sub optimal, |
| | | | | outcomes include multiple gap |
| | | | | fills (one per message) and |
| | | | | Sequence Reset - Reset scenarios. |

ttSession Level - Outgoing Sequence Number Too High

| | Receiving | Sending | | |
|---|---|---|---|---|
| Time | Action | Action | Condition/Stimulus | Comments |
| 1 | | Send | | Set outgoing sequence numbers |
| | | Heartbeat | | too high. |
| 2 | Resend | | Outgoing sequence | Issues a resend request for |
| | Request | | numbers too high. | missing messages. Warn if the |
| | | | | resend request specifies a specific |
| | | | | EndSeqNo, rather than 999999. |
| 3 | | Send | | Responds to resend request with a |
| | | Sequence | | sequence reset and a gap fill for |
| | | Reset- | | missing messages. User should |
| | | Gap Fill | | be able to verify gap fill. |

ttSession Level - Outgoing Sequence Number Too Low

| | Receiving | Sending | | |
|---|---|---|---|---|
| Time | Action | Action | Condition/Stimulus | Comments |
| 1 | | Send | | Set outgoing sequence numbers |
| | | Heartbeat | | too low. |
| 2 | Logout/ | (Send | Outgoing sequence | Verify client disconnect. |
| | Dis- | Logout) | numbers too low. | |
| | connect | | | |

ttSession Level - Drop and Restore Connection

| | Receiving | Sending | | |
|---|---|---|---|---|
| Time | Action | Action | Condition/Stimulus | Comments |
| 1 | Order | | | |
| 2 | | Send Order | | |
| | | Ack | | |
| 3 | | Disconnect | Unexpected | |
| | | | Commumi- | |
| | | | cations Failure | |
| 4 | | Queue | | Queue a partial and a final fill |
| | | outgoing | | message and wait for logon. |
| | | Messages | | |
| 5 | Logon | | | |
| 6 | | Send Logon | | Set Logon message sequence |
| | | | | number too high to simulate all |
| | | | | queued messages while |
| | | | | disconnected. |
| 7 | Resend | | Outgoing | Warn if the resend request |
| | Request | | Sequence | specifies a specific EndSeqNo, |
| | | | number too | rather than 999999. |
| | | | high | |
| 8 | | Send Queued | | Verify that client receives all |
| | | Partial | | messages. |
| | | Execution and | | |
| | | Execution for | | |
| | | remaining | | |
| | | shares, then a | | |
| | | Gap Fill. | | |

ttSession Level - Stop Incoming Heartbeats

| | Receiving | Sending | Condition/ | |
|---|---|---|---|---|
| Time | Action | Action | Stimulus | Comments |
| 1 | Heartbeat | | | Pretend that we miss heartbeat |
| 2 | Heartbeat | | | Pretend that we miss heartbeat |
| 3 | | (Send | | Send a test request. Validate |
| | | Test | | the heartbeat that comes back, |
| | | Request) | | but ignore it as we are |
| | | | | simulating a down connection. |
| 4 | Heartbeat | | | |
| 5 | | Send | | Verify that the client was |
| | | Logout | disconnected. | |
| | | Dis- | | |
| | | connect | | |

ttSession Level - Stop Outgoing Heartbeats

| | Receiving | Sending | Condition/ | |
|---|---|---|---|---|
| Time | Action | Action | Stimulus | Comments |
| 1 | Heartbeat | | | |
| 2 | Test | | Did not | Validate the test request, but |
| | Request | | receive | then ignore it as we are |
| | | | Heartbeat. | simulating a down connection. |
| 3 | Logout | | Did not | Validate logout but do not |
| | | | receive | respond since the connection |
| | | | response to | is down. |
| | | | test request. | |
| 4 | Dis- | | | Validate that they |
| | connect | | | disconnected. |

Using the Certification Engine as an Internal Testing Tool:

The Certification Engine is a powerful tool for certifying FIX connectivity with counterparties. But the Certification Engine can also be used as a means to test a firm's internal systems more thoroughly, and also as a way to fine-tune a firm's scripts for external certification with counterparties. The description below describes how the Certification Engine can be used from the start as a tool for building precise testing profiles that can perfect later certification testing with counterparties.

Review of Certification Testing with an External Counterparty: The Certification Engine is a powerful tool for certifying connectivity and verifying compatibility of business systems with counterparties. It is a platform for automating either side of the certification process, thus reducing the need for human interaction on one side of the testing cycle. The Certification Engine server plays the role of one of the counterparties. In the FIX-based embodiment, the Certification Server can simulate the sell-side partner (e.g., the broker) for the buy side (e.g., the money manager) and vice versa. In one embodiment, the Certification Engine is implemented to handle the FIX protocol, but it is also extendable to other existing and emerging network messaging formats.

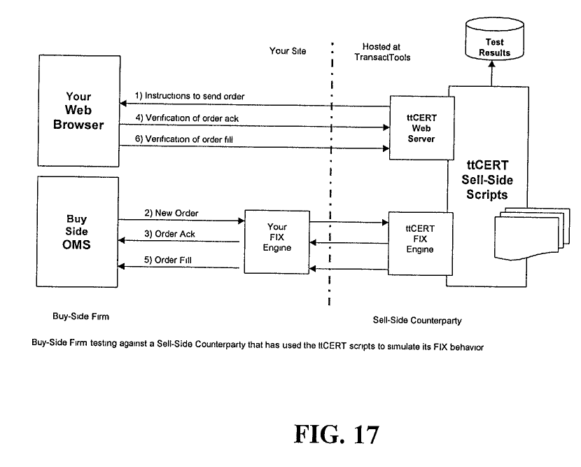

In a typical sell-side (broker) implementation (see FIG. 17), the firm hosting the Certification Engine (the broker, in this case) simulates its FIX implementation and internal systems (e.g., OMS) for its counterparties. Those counterparties, in turn, interact with the scripts running in the Certification Engine. The counterparties initiate FIX connections, send orders, and are asked to verify the executions that they receive from the host. The scripts validate all of the incoming orders from the counterparties, and create and send executions.

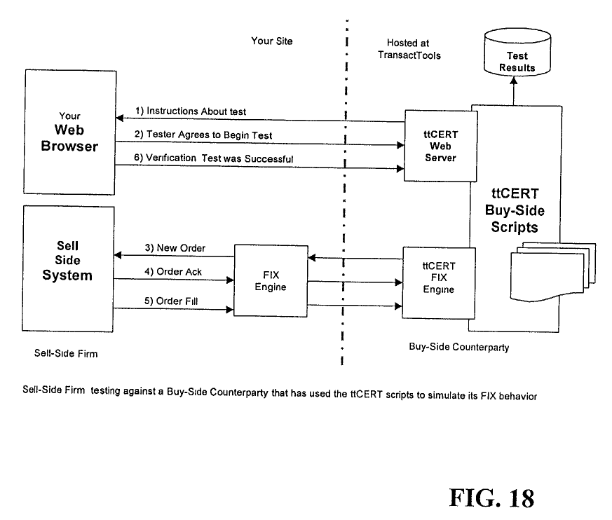

In a typical buy-side implementation (see FIG. 18), the host company (e.g., a money manager) also simulates its FIX implementation and internal OMS for its counterparties. The host's counterparties also interact with scripts running in the Certification Engine, but in the opposite manner of the sell-side firm's counterparties—the buy-side's counterparties receive and verify orders, and send back executions. The scripts create the orders and validate all of the incoming executions.

Using the Certification Engine to Test Internal Systems and FIX Implementation: In addition to being used to certify counterparty connectivity, the Certification Engine can also be used as a means to test internal systems more thoroughly, and also as a way to fine-tune scripts for external certification with counterparties. This section describes how the Certification Engine can be used as a tool for building testing profiles that can enhance later testing with outside firms.

To thoroughly test a FIX implementation, a user needs to provide simulated order flow to and from the user's counterparties. Unlike when the user tests against an external counterparty's scripted implementation, when using the Certification Engine as an internal testing tool, it is necessary for the user to write the user's own counterparty scripts.

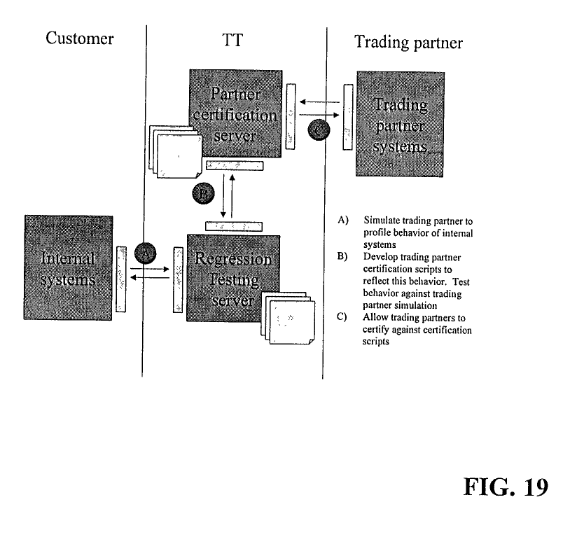

FIG. 19 illustrates the progressive role that the Certification Engine can play in a user's test plan. This approach to testing an internal OMS (or any other internal application for business transactions) is just like certification testing against an external counterparty's Certification Engine implementation, except that the user substitutes the user's own scripts for those of an external counterparty. The user writes the user's own counterparty scripts, hosts them on a Certification Engine server, and uses them to test the user's OMS.

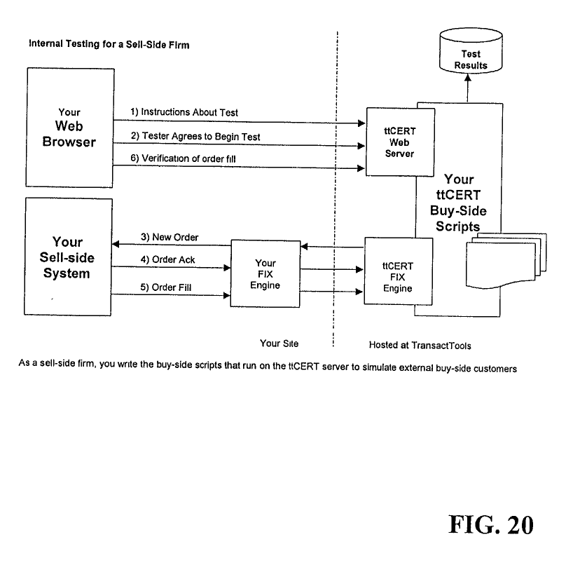

For example, a user for a sell-side firm would write buy-side scripts to run as the user's simulated counter party when performing internal testing. See FIG. 20. The sell-side user would script the sending of orders, order cancels, and changes, and perform the validation of the executions or rejects that the user's system generates. This type of internal testing requires the user to actively participate in the testing process, verifying and possibly entering data.

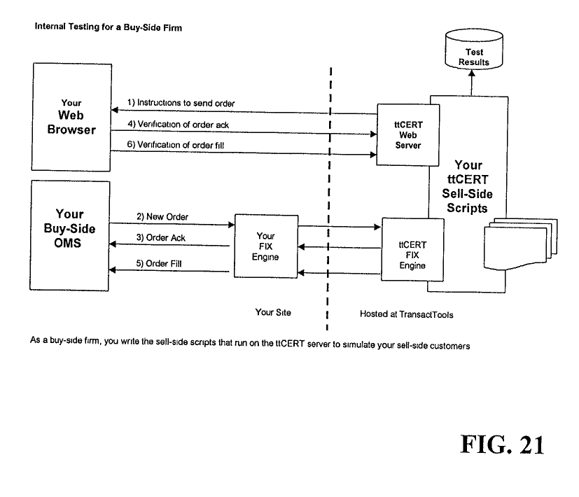

A user for a buy-side firm would write sell-side scripts to run as the user's simulated counter party when performing internal testing. See FIG. 21. Scripting the sell side requires the user to validate the orders that the user's system generates, and to send executions or rejects back to the user's OMS.

Just as a user can use Certification Engine scripts to test the user's own systems, a user can also use scripts to test the user's Certification Engine scripts. This testing approach helps to ensure that the user's Certification Engine implementation, as well as the user's production systems, perform the way the user expects them to.

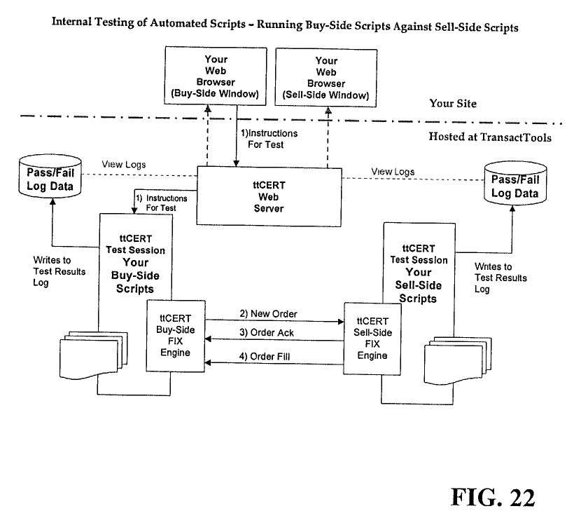

IN a FIX-based embodiment, tsting a user's Certification Engine scripts requires that sell-side scripts have simulated buy-sides, and buy-side scripts have simulated sell-sides. See FIG. 22. This type of internal testing (automating the scripts) requires minimal web-browser interaction by a user: the user does not have to verify the data displayed in the course of processing, or intervene during the execution of the scripts.

Loopback testing can be performed on sites with two opposite-side messaging engines. For service bureaus, ECNs, or any site with two different counterparty messaging engines, this type of test configuration enables thorough testing of a user's application in a real-time scenario.

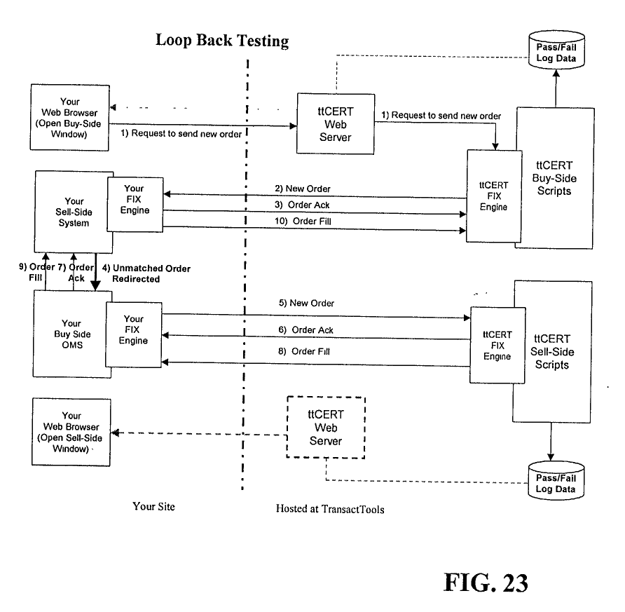

If a user's internal systems include an opposite-side messaging component (in other words, an outbound order router for a sell-side firm, or an inbound order router for a buy-side firm), the user can build the “loop back” system depicted in FIG. 23 using the Certification Engine.

FIG. 23 depicts a sell-side firm that redirects an unmatched order to an internal buy-side system. The tester/user arranges for the buy-side script simulating the tester's counter party to send an order to the tester's in-house sell-side system for execution. There is no opposite side match for this order, so it is redirected to the in-house buy-side system, which then sends it to the simulated sell-side for execution. The user can then view the test results that are recorded in the pass/fail data logs.

In many sell-side cases, without the component to route orders back to the sell-side scripts, the orders might be handled by a simulated fill generator. While such systems are useful for ad-hoc testing, their real-time nature may run counter to one of the goals of scripted testing: testing scenarios that are very difficult to duplicate in a real-time environment. For example, it may be very difficult to generate an order fill while a cancel or change is pending, due to the difficulty of coordinating the timing of the inbound order and cancel with the outbound acks and fills.

Although the subject invention has been described with reference to preferred embodiments, numerous modifications and variations can be made that will still be within the scope of the invention. No limitation with respect to the specific embodiments disclosed herein other than indicated by the appended claims is intended or should be inferred.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of emulating an emulated transaction processing system to enable compatibility testing of said emulated system with a testing system, comprising the steps of:
defining a test plan;
identifying unique aspects of the tested system;
modifying scripts to model said emulated system, including said unique aspects; and
permitting said testing system access to a server running said scripts.

2. A method as in claim 1, wherein said emulated system uses a messaging engine.

3. A method as in claim 2, wherein said messaging engine is a FIX engine.

4. A method as in claim 1, wherein said scripts comprise session-level scripts.

5. A method as in claim 1, wherein said scripts comprise application-level scripts.

6. A method as in claim 2, wherein said step of modifying scripts comprises the steps of:
dynamically determining the behavior of the messaging engine by running tests and logging test results;
parsing said logged test results; and
determining how said messaging engine validates incoming messages and composes outgoing messages.

7. A method as in claim 6, wherein tests are run, logged, and parsed using test scripts.

8. A method as in claim 6, further comprising adding customized wizpages.

9. A method of testing compatibility of a testing system and an emulated transaction processing system, comprising the steps of:
establishing communication with an emulating system that emulates behavior of the emulated system using scripts;
receiving a test data request from said emulating system;
sending test data to said emulating system, wherein said test data corresponds to said test data request; and
receiving a message from said emulating system indicating that said test data was successfully received.

10. A method as in claim 9, wherein said test data comprises an order.

11. A method as in claim 9, further comprising the step of providing a visual indication of test results to a user.

12. A method of emulating an emulated transaction processing system to enable compatibility testing of said emulated system with a testing system, comprising the steps of:
emulating behavior of said emulated system using scripts;
establishing communication with the testing system;
sending a test data request to said testing system;
receiving test data from said testing system, wherein said test data corresponds to said test data request; and
sending a message to said testing system indicating that said test data was successfully received.

13. A method as in claim 12, wherein said test data comprises an order.

14. A method as in claim 12, further comprising the step of providing a visual indication of test results to a user.

15. Software for emulating an emulated transaction processing system to enable compatibility testing of said emulated system with a testing system, comprising:
user interface software;
script writing software;
application messaging software using a network connection;
script executing software; and
test scripts.

16. Software as in claim 15, wherein said messaging software uses a FIX protocol.

17. Software as in claim 15, wherein said messaging software uses a FIXML protocol.

18. Software as in claim 15, wherein said messaging software uses a FPML protocol.

19. Software as in claim 15, wherein said messaging software uses a SWIFT protocol.

20. Software as in claim 15, wherein one or more of said test scripts comprise event handling script functions.

21. Software as in claim 15, further comprising dynamic HTML generating software controllable by a script.

22. Software as in claim 15, further comprising software configured to provide a graphical user interface.

23. Software as in claim 22, wherein said graphical user interface is enabled to provide a visual indication of test results.

24. Software for emulating an emulated transaction processing system to enable compatibility testing of said emulated system with a testing system, comprising:
a protocol definition;
a first set of scripts implementing said protocol definition; and
a second set of scripts linked to the first set of scripts, said second set of scripts emulating a transaction processing system that implements said protocol definition.

25. Software as in claim 24, comprising:
a script interpreting engine embedded into a messaging engine; and
an application programming interface between said messaging engine and said second set of scripts, wherein said application programming interface is configured to pass inbound and outbound messages to said second set of scripts.

26. Software as in claim 25, wherein said application programming interface is configured provide to said second set of scripts access to attributes of said messages.

27. Software as in claim 25, wherein said application programming interface is configured to enable said second set of scripts to handle inbound and outbound messaging errors.

28. Software as in claim 25, wherein said application programming interface is configured to enable said second set of scripts to control messaging engine behavior by returning true or false values from script functions.

29. Software as in claim 25, wherein said application programming interface is configured to provide said second set of scripts with access to services provided by a protocol engine or an application connected thereto.

30. Software as in claim 25, further comprising software for associating one or more scripts with one or more event sources, such that an instance of a script maintains program state across several different events and messages.

31. Software as in claim 25, further comprising software for declaring scripts and enabling said scripts to include libraries of other scripts.
